(19) United States
(12) Patent Application Publication
(10) Pub. No.: US 2025/0140444 A1
(43) Pub. Date: May 1, 2025

(54) ELECTRICAL CABLE FOR CONNECTION TO AN ELECTRICAL COMPONENT

(71) Applicant: Murrelektronik GmbH, Oppenweiler (DE)

(72) Inventors: Olaf PREIN, Lügde-Rischenau (DE); Marco BOSCH, Weilheim a. d. Teck (DE); Heiko FEISST, Schlierbach (DE); Christian KÜBLER, Backnang – Maubach (DE)

(73) Assignee: Murrelektronik GmbH, Oppenweiler (DE)

(21) Appl. No.: 18/925,110

(22) Filed: Oct. 24, 2024

(30) Foreign Application Priority Data
Oct. 27, 2023 (EP) EP23206425.3
Jun. 6, 2024 (DE) 10 2024 115 858.1

(51) Int. Cl. H01B 7/36; H01R 4/2406; H01R 13/00; H01R 13/52; H01R 13/58; H01R 43/01

(52) U.S. Cl. CPC H01B 7/363; H01R 4/2406; H01R 43/01; H01R 13/005; H01R 13/5205; H01R 13/5845

(57) ABSTRACT

The invention relates to an electrical cable (2) for connection to an electrical component (20), wherein the cable (2) has at least one electrical conductor (4).

### RELATED APPLICATIONS

This application claims the benefit of priority of Germany Patent Application No. 10 2024 115 858.1 filed on Jun. 6, 2024 and Europe Patent Application No. EP23206425.3 filed on Oct. 27, 2023, the contents of which are incorporated by reference as if fully set forth herein in their entirety.

### FIELD AND BACKGROUND OF THE INVENTION

The present invention relates to an electrical cable according to the type defined in more detail in the preamble of claim 1. Furthermore, the invention relates to a component, a connection system and a method.

It is known from the state of the art that electrical cables are used pre-assembled during the installation of an electrical system or are only assembled to a desired length in the field. However, the use of pre-assembled cables is inflexible and may be limited by the availability of the corresponding cables. Field assembly, on the other hand, is more flexible, but is often a time-consuming process.

To assemble the cable, the cable may first be stripped and crimped and then connected to a plug connector. A crimping tool, for example, is used to securely connect the plug connector to the conductors of the cable by applying pressure and deformation. A stripping tool may also be used to cut off the outer insulation of the cables without damaging the underlying conductors.

Furthermore, it is known from the state of the art that current Ethernet technology is often too complex and over dimensioned for applications in the Industrial Internet of Things (IIoT). In particular, conventional plug connectors and cables are in many cases less optimal for use at field level. This makes the integration of sensors and other components more difficult, especially due to the cabling requirements and the limited cable length. A simplified Ethernet standard, Single Pair Ethernet (SPE), already offers a solution here by combining long cable lengths, compact design and robust cabling.

However, conventional solutions are still very costly when it comes to always providing the right cable length in the field.

It is therefore a task of the present invention to at least partially eliminate the disadvantages described above. In particular, it is a task of the present invention to further simplify the installation technology and to provide the correct cable length for an application in an improved manner. In particular, an improved, more flexible and/or simpler connection technology that may be used in the field is to be provided.

### SUMMARY OF THE INVENTION

The subject matter of the invention is a cable having the features of claim 1, a component having the features of claim 13 and a connection system having the features of claim 24. Further features and details of the invention are apparent from the respective subclaims, the description and the drawings. Features and details described in connection with the cable according to the invention naturally also apply in connection with the component according to the invention, the connection system according to the invention and the method according to the invention, and vice versa in each case, so that reference is or may always be made reciprocally to the individual aspects of the invention with regard to the disclosure.

The object of the invention is in particular a, preferably electrical, cable for connection to a, preferably electrical, component. The component is, for example, a plug connector or a device such as a sensor or actuator or a fieldbus module.

For example, a plug connector of type M8 or M12 or RJ45 may be used as a plug connector. Furthermore, the plug connector may be designed as an essentially cylindrical (such as M8, M12) or rectangular (e.g. RJ45) plug connector. Furthermore, the plug connector may have a diameter, in particular a maximum diameter, in the range from 1 mm to 30 mm, preferably 2 mm to 20 mm, preferably 5 mm to 14 mm. Specifically, the diameter may be essentially 8 mm for M8 and essentially 12 mm for M12. In particular, the diameter may refer to the outer diameter of a thread of the plug connector, which is used to attach it to a device. The cable may in turn have an outer diameter in the range of 1 mm to 30 mm, preferably 2 mm to 20 mm, preferably 3 mm to 10 mm. In the case of M12 cables, for example, the diameters may vary in the range from 4 mm to 6 mm.

It is also possible for the cable to be designed as a power or data or hybrid cable. As a hybrid cable, the individual cable may be used for both energy and data transmission, for example. For example, one or more data lines and one or more power lines are provided for this purpose. The respective cable, in particular the data and/or energy cable, may have an electrical conductor which is surrounded by a sheath, in particular an insulating sheath or shielding. The shielding may be made of an electrically conductive material, for example to shield against electromagnetic interference. Materials such as copper or aluminum may be used here. On the other hand, the insulating sheath may be made of an electrically insulating material. Materials such as ceramic, glass or plastic may be used here. The respective data line may be designed as an electrical or optical data line and preferably as a fieldbus and/or Ethernet line.

The component and in particular the plug connector may be used to establish a reliable and secure connection with the cable, in particular for an application in the field of automation technology. This may make it possible to receive electrical current for power transmission and/or signals for data transmission and/or at least one other medium from the cable and/or transmit it on to a device.

The component may have at least one or multiple contact means, each of which may be electrically and/or mechanically contacted with an assigned (associated) conductor of the cable in order to preferably establish the connection between the cable and the component. In this case, several contact means of the component may or should also be provided for a reliable and complete connection in the case of several conductors of the cable, and the contact means may be electrically and/or mechanically connected to the conductors. In other words, an associated contact means may be provided for each conductor of the cable to be contacted, which is connected to the associated conductor accordingly. The assignment between contact means and conductor may, for example, be made according to a predetermined assignment. It may be provided that only one contact means is connected (contacted) to exactly one associated conductor at a time until all contact means of a component have each been contacted with an associated conductor in order to complete the connection.

The respective contact means may be designed as an electrical contact means, i.e. electrically conductive, and the respective conductor may be designed accordingly as an electrical conductor. When connecting the cable to the component, the assignment of the contact means may be taken into account, i.e. the contact means are connected to the conductors of the cable provided for this purpose. The assignment thus defines which conductors are assigned/belong to which contact means. In other words, it depends on the specific arrangement and/or assignment of contact means of the component with the conductors of the cable.

The cable may have at least one electrical conductor. It is preferred if at least two or three or four or more or a maximum of 10 or a maximum of 15 or a maximum of 20 electrical conductors of the cable are provided. Each of the electrical conductors may particularly preferably be designed as a strand. In particular, a strand is understood to be an electrical conductor that has thin single wires and is therefore easy to bend, which is made predominantly of copper, for example. The single wires may be enclosed by a common insulating sheath (insulation); in this case, this cable with the conductor may also be referred to as a stranded cable.

Furthermore, at least one coding may be provided on the cable. The coding may be formed spatially, i.e. in particular three-dimensionally, on the cable. Furthermore, the coding may be provided on a contacting and, in particular, cut surface of the cable. It is also possible for the coding to be provided on several or all cross-sections of the cable in order to provide a possible contacting and/or cut surface. This is the case, for example, if the coding extends repeatedly or continuously in the longitudinal direction of the cable in order to be provided on a cut surface even if the cable is cut open at any point along this extension.

The coding may be used to specify (particularly predetermine) a specific arrangement and/or (in particular the above-described) assignment of, in particular electrical, contact means of the component with the, in particular electrical, conductors of the cable, preferably to specify and/or guide the connection. Coding may preferably be understood to mean a systematic shaping and/or systematic arrangement of contacts and/or mechanical elements in order to ensure a specific connection configuration. The coding may thus be used to avoid incorrect connections and to ensure the correct alignment of the component (e.g. in the form of a plug connector) with respect to the cable during the connection process. The coding thus advantageously defines a correct orientation of the component, i.e. the correct orientation of the cable, preferably in relation to the cable, and enables optimized signal transmission and power supply by ensuring compatibility. The arrangement of the contact means with the conductors may, for example, denote the spatial arrangement, e.g. according to the assignment, i.e. a predetermined assignment, so that the “correct” contact means (in particular a contacting movement) contact the “correct” conductors.

The connection between the component and the cable may be made directly at a contacting surface and in particular a cut surface of the cable. The contact surface may designate a surface and, in particular, a cross-section through the cable at which the respective conductor of the cable is or may become accessible from the outside for contacting with the contact means of the component. The surface may be arranged orthogonally to the axial direction of the cable. The respective conductor of the cable may directly adjoin an outer area of the cable at the contact surface and thus be connected to the contact means of the component without cutting through the sheath and/or insulation of the cable. The respective conductor may also be separated at the contact surface in alignment with the contact surface. The cable may be designed to provide such a contact surface after the cable has been cut to size.

The cable may be formed in such a way, preferably after cutting the cable to size, that the respective conductor of the cable is or becomes accessible for contacting with an associated contact means. This is to be understood in particular as meaning that the respective conductor is or becomes accessible from the outside (i.e. outside the cable), in particular may be contacted electrically from the outside without further measures such as stripping. This is made possible in particular by the fact that the respective conductor (for contacting) has an exposed conductor cross-section, in particular as soon as the cable has been cut to size. Alternatively or additionally, the cable may also have the contact surface and/or the accessible conductor in its original state (e.g. as delivered without being cut to size).

The coding may be provided directly on the cable (and thus not or not only on the plug connector). In particular, the coding may be formed between and/or in the area and/or through the conductors and/or the insulation and/or in or on the cable sheath (e.g. inner and/or outer sheath) on the cable. Coding is already known in plug connectors, in particular by means of electrical coding, in which the contacts are arranged in such a way that only the correct electrical connection is possible. According to the invention, this coding may be transferred to the cable, i.e. alternatively or additionally provided on the cable, for example in the form of a mechanical and/or electrical coding. The coding may optionally also be referred to as a coding or connection structure.

While coding in the form of mechanical coding preferably involves a special shape of at least part of the cable or on the cable being systematically predetermined, in the case of electrical coding the conductors of the cable may be arranged in such a way that only the correct electrical connection to the component is possible. Forming the coding on the cable may have the advantage that the connection process between cable and component is significantly simplified and accelerated. This is due to the fact that the component may be connected directly and immediately to the cable.

It is possible that the cable according to the invention has a coding and/or a connecting structure which runs in the axial direction (longitudinal direction) of the cable and/or the conductors of the cable. The connecting structure may have the coding and/or a plug-in structure and/or a (geometric) profile. Furthermore, the connecting structure, in particular the coding and/or the plug-in structure and/or the profile, may extend over substantially the entire or predominant length of the cable and/or be provided continuously and/or repeatedly. In other words, the connecting structure may have a structural section which is repeated in the axial direction of the cable.

The coding or the connecting structure, specifically the structural section and/or the plug-in structure, may comprise at least one or more or exactly one cavity, preferably each in the form of a channel. A part of the component, such as a respective guide pin, may be plugged into the cavity or one or each of the cavities. The coding may be provided by a special geometric shape (in particular polygon) of the (respective) cavity. Furthermore, the coding may also be defined by a number of corners and/or edges of this shape. It is also conceivable that the coding is provided by several of the cavities, e.g. based on the arrangement and/or size and/or possibly different shapes of the cavities.

In particular, the coding or connection structure makes it possible to significantly reduce the necessary assembly steps for a connection process between the cable and component. Furthermore, even after the cable has been cut to size, the cut cable as such may already have the necessary structure to enable direct connection of the component.

It is possible that the cut cable has a plug-in structure, in particular provided by the coding and/or connection structure. In other words, the cable may be designed to have a plug-in structure on the cut surface even after it has been cut to length. This has the advantage that the cable may be connected directly to the component after it has been cut to a desired length. This is made possible in particular by the fact that the plug-in structure is provided continuously or repeatedly in the axial direction along the cable. As such, and therefore immediately after cutting, the cut cable may already have the necessary structure on its cut surface to enable direct connection of the component.

It is also conceivable within the scope of the invention that (at least) one contact surface is provided on the cable, at which the respective conductor is accessible for contacting with the associated contact means, and at which the coding is preferably provided. The contact surface may lie in the cutting plane of the cable. In other words, the contact surface may be located at the plane at which the cable was cut. Accordingly, the cable may also be designed to have a contact surface, preferably with the coding, on the cut surface after a cut. The conductor or conductors may adjoin or protrude outwards from an interior of the cable at the contact surface or cut plane and be visible from outside the cable. Furthermore, the respective conductor preferably protrudes from the contact surface or is located in a recessed position in the cable. It is also conceivable that a respective exposed conductor cross-section is also located in the cutting plane. This provides an easy-to-connect structure that allows the cable to be inherently designed as a plug or socket.

It is also advantageous if the respective contact means is designed to be inserted, preferably pierced, on and/or through the exposed conductor cross-section of the associated conductor. In other words, in the case of several conductors, each of the contact means may be inserted into a conductor cross-section provided for this purpose. Furthermore, the respective conductor with its (respectively) exposed conductor cross-section and the (respectively) inserted, preferably pierced, contact means may be at least partially surrounded by an insulating sheath. It is therefore not necessary to strip the conductor—i.e. remove the insulating sheath—in order to make the connection. This simplifies and speeds up the installation of the cable.

The special design of the cable according to the invention has the advantage that, when connecting the cable to the component, it is not necessary to first strip the cable in a complex process and, for example, use crimp connectors to connect a plug connector to the cable.

Instead, it may be possible to connect the component directly to the cut cable, as the cable already has a structure, preferably a plug-in structure and/or coding, on the cut surface for mechanical and/or electrical contacting. The conductors of the cable may also be designed in such a way that they already provide a favorable contact surface at the cut surface. This is made possible in particular by strands with a diameter that allows contact means to be plugged and/or pierced into the strands.

It is also advantageous if the at least one coding comprises a mechanical and/or geometric coding of the cable, in which a geometric profile, in particular a spatial shape and/or contour, extends in an axial direction of the cable, e.g. is arranged continuously or repeatedly. The profile may define at least one cavity and in particular guide cavity, preferably the spatial shape and/or contour of the cavity. The at least one cavity may be provided for a pin or the at least one guide cavity (for guiding) may be provided for a guide means such as a guide pin of the component, so that a specific orientation of the component (relative to the cable) is predetermined for the connection and/or the connection of the component to the cable is blocked in the event of a deviation from the specific orientation. The specific orientation may also be predetermined by the specific shape of the at least one cavity, e.g. by the shape of the wall and/or the opening formed by the wall. The opening may, for example, have a rectangular or trapezoidal shape that corresponds to the shape of the pin, in particular the guide pin. This ensures that the component or pin is inserted in exactly the right position and is not skewed or twisted. In other words, the opening of the cavity may be shaped such that the at least one contact means and/or the at least one pin of the component may only be inserted therein in the correct orientation of the component. Furthermore, the at least one cavity may have a length that corresponds to the length of the pin that is inserted into the respective cavity. It is also conceivable that a plurality of cavities form a grid on the contacting and/or cut surface of the cable, which are arranged in such a way that the at least one contact means and/or the at least one pin of the component may only be inserted there in the correct orientation of the component.

It is further possible that the or at least one further cavity and in particular a guide cavity is designed for the transmission of a fluid, preferably for the transmission of a medium such as air or a liquid. Accordingly, the cable may serve not only to transmit electrical energy, but optionally also to transmit the fluid, such as a medium such as air or liquid. In other words, the coding may also be used to transmit a medium that is different from electrical energy. This enables the cable to be used in a variety of ways. The cable may therefore be designed not only as an electrical cable, but alternatively or additionally also as an air and/or fluid cable.

According to a further possibility, it may be provided that the at least one coding comprises a geometric and/or extruded profile of the cable and/or a tube and/or a grommet, the coding being arranged in the cable, in particular inside a cable sheath of the cable, and/or outside the cable sheath and/or on the cable sheath. In particular, the mechanical and/or geometric coding may be provided by the cable having a specific geometric profile. The specific geometric profile may be provided, for example, by the shape of at least one cavity and/or an opening of a cavity of the cable.

Furthermore, boundaries such as walls of the cable may be provided, which form the opening and the cavity, for example. The boundaries may be arranged and shaped in such a way that the specific geometric profile is created. The boundaries are made of plastic, for example. The boundaries and/or the profile may advantageously be extruded directly on the cable, e.g. by forming the boundaries and in particular walls in the cable.

It is also possible for the mechanical and/or geometric coding and/or the profile to be subsequently attached to the cable, e.g. by means of a guide device and/or a grommet, preferably a guide grommet and/or cable sleeve, and/or a hose. The grommet may be attached to the cable from the outside. The hose may also be guided in the cable, for example. This may make it easy to produce the coded cable. Furthermore, the coding may be arranged in the cable, in particular within a cable sheath of the cable (i.e. in particular in the channel formed by the cable sheath), and/or outside the cable sheath and/or on the cable sheath.

Furthermore, a shape of the coding may deviate from the (in particular original, geometric) basic shape of the cable, preferably cylindrical basic shape of the cable, such as a cylindrical structure provided by the cable sheath. In other words, the coding may be a structure specially provided on the cable, which is provided on the cable specifically for the purpose of enabling the specific arrangement and/or assignment as described above.

The cable may also optionally have a grommet, particularly cable sleeve. The grommet may have a specific profile, e.g. a specific square or round shape, which provides the coding. The grommet may further serve to insulate and mechanically protect the electrical conductors within the cable. The grommet may be made of a high temperature resistant material such as polyethylene or silicone and designed to provide optimum strain relief for the conductors contained within the cable. In addition, the grommet may be provided with a special coating that minimizes electrical conductivity and thus reduces the risk of short circuits. The grommet may further comprise one or more chambers that serve to separate the individual conductors from each other, thus improving electrical insulation and/or (through the shape and/or arrangement of the chambers) providing the coding.

The at least one coding may be formed by means of a rotationally symmetry-free cross-section of the cable, in particular by a rotationally symmetry-free inner and/or outer contour of the cable. This may ensure that the cable may only be electrically connected to the component in a position that corresponds to a clear assignment of the contact means to the electrical conductors of the cable. The rotationally symmetry-free outer contour may be formed by means of a cable sheath or outer circumference of the cable, preferably in that the cable has a cross-section with a circular basic shape and at least one recess, in particular a groove, and/or at least one elevation, in particular a bead. Preferably, the recess or elevation, in particular the bead, is the coding. Alternatively, the outer contour may be a free form or a polygonal shape. The inner contour may be formed by means of a circular fluid line, which forms the coding due to its position and/or shape within the cross-section of the cable. Alternatively, the fluid line may have a free form or the shape of a polygon. Due to the coding, the component with the coding may be regarded as a key and the component with the matching counter-coding as a lock. This may ensure the intended specific contacting between the conductors and the contact means. It is also conceivable within the scope of the invention that the at least one coding comprises, as an alternative to or in addition to the mechanical and/or geometric coding, an electrical coding of the cable, in which a systematic arrangement of the electrical conductors of the cable is provided, so that a specific assignment of the electrical contact means of the component is predetermined for the connection. This may be understood to mean that the conductors of the cable have a predetermined arrangement in which the conductors have different (in particular lateral) distances from each other in accordance with a coding specification. These differences must also be provided for in the contact means of the component, i.e. the component must have a corresponding counter-coding so that the connection is possible. This ensures that a correct electrical connection is made between the contacts.

It is also advantageous if the electrical conductors of the cable are each formed as a strand in order to form (in particular in the axial direction of the conductor) a receptacle for inserting at least one electrical contact means of the component, preferably for inserting and/or piercing the respective contact means in the form of a contacting tip, in particular in the axial direction of the cable and/or on a contact surface, wherein preferably the conductors on the contact surface are directly adjacent to an outer region of the cable. The design as a strand has the advantage that the strand may have several single wires, which may provide better accommodation for the contact means due to their flexibility. In particular, the mechanical deformability of the single wires may therefore be utilized during the connection in order to insert the contact means into the strand and to obtain reliable contacting when inserting/piercing the contact means.

To connect and preferably to insert the respective contact means, i.e. in particular for insertion and/or piercing, a mechanical force may be exerted on the cable and/or conductor in the axial direction of the cable (i.e. longitudinal direction of the cable) and/or conductor. In particular, this may trigger a contacting movement of the component and/or the cable. However, a leading contact means and/or a (possibly also leading) guide pin of the component may first be applied to the cut surface of the cable in order to then insert this contact means into an associated (assigned) conductor or to insert this guide pin into at least one cavity of the cable. In this process, the other contact means of the component finally touch the conductors of the cable at the cut surface. The force may then be exerted in the longitudinal direction of the cable to insert/pierce the contact means into the conductors and thus cause the contacting movement. This process may also be referred to as “piercing”, but unlike conventional solutions, this is not done on the side of the cable, but axially on the cut surface of the cable.

Furthermore, it may be provided that a recurring marking is provided which indicates a depth of penetration of the electrical contact means, preferably in the form of piercing means. The marking may, for example, be provided on the outside of a cable sheath, e.g. printed on. The marking may be repeated at fixed intervals in the longitudinal direction of the cable in order to obtain an indication of the depth at which the contact means have been correctly inserted, starting from the cut surface, after the cable has been cut. This makes the connection even simpler and more reliable. The marking may also help with the orientation of the cable for the connection.

The electrical conductors may preferably merely and/or directly extend to and/or adjoin a or the contact surface of the cable, in particular on the end face, preferably in order to enable the contact means, in particular in the form of contacting tips and/or piercing means, to be pierced into the electrical conductors on the contact surface, whereby the contact surface may preferably run transversely, in particular perpendicularly, to the direction in which the cable extends,

and wherein in particular the contact surface may form a cut surface of the cable, at which the cable has preferably been shortened to a desired length, and/or a cable end of the cable. Preferably, the contact surface may be formed by a cut at any point along the extension of the cable, in particular if the coding extends over the entire length of the cable. Preferably, the contact means are designed in such a way that it is only possible to pierce the electrical conductors of the cable by means of the contact means, in particular without cutting.

The cable may have several contours along its outer circumference, preferably at regular intervals from one another, in particular strain relief contours, particularly preferably in the form of circumferential recesses, in particular grooves or notches, or elevations, in particular beads or steps, preferably for a heat-shrink tubing or strain relief. The strain relief contour may be used to prevent an accidental disconnecting of the electrical connection between the cable and the component when an unintentional pulling on the cable occurs. Alternatively, the coding on the outer circumference of the cable or cable sheath may form the strain relief contour. In other words, the strain relief contour could extend along the entire length of the cable if the coding extends along the entire length of the cable. This allows the cable to be shortened at any point without affecting the function of the strain relief. Furthermore, there is no need to provide a separate strain relief contour for the coding in this way, as the coding already forms the strain relief contour, which significantly simplifies the production of the cable.

The cable may have, in particular on the outer circumference of the cable and/or on the contact surface, a microencapsulation to form a seal, wherein the contents of the microencapsulation may be released in particular by the supply of heat, radiation, in particular the supply of light, preferably in the form of ultraviolet light, contact with an activation substance or the supply of light in combination with moisture, or wherein the cable, in particular on the outer circumference and/or on the contact surface, may have an activation substance for a microencapsulation in order to release the contents of the microencapsulation on contact with the microencapsulation in order to form a seal. If the cable has the activation substance, it is preferred if the component has the microencapsulation, and vice versa. Such microencapsulation eliminates the need for a manufacturing step involving external handling of a sealing compound. The microencapsulation may have a sealing compound or an adhesive, in particular for electrical insulation. Alternatively, the microencapsulation may comprise a chemical substance which, when released, forms a substance-to-substance bond for sealing. Alternatively or additionally, the seal may be formed at the end face of the cable, preferably at the contact surface. For this purpose, the microencapsulation and/or the activation substance may be arranged accordingly, preferably at the contact surface and/or at a point of the component that comes into contact with the contact surface. In order to allow the light or radiation to reach the microencapsulation, it may be provided that the component comprises a material which is permeable, in particular transparent, to the light or radiation. Preferably, the component may be or be manufactured for this purpose by means of a two-component injection molding process. The first material component of the injection molding process may be a plastic that is permeable, in particular transparent, to light or radiation. The second material component of the injection molding process may be another plastic, for example an electrically insulating material or a material that gives the component its strength.

The electrical conductors of the cable may preferably be twisted together, in particular in the form of one or more twisted pairs, twisted threes or twisted fours. The at least one coding may have a continuous course along the length of the cable and/or a course matched to the twisting such that at any point along the length of the cable the at least one coding and the electrical conductors may have the same relative position to one another, in particular in a plane transverse, preferably perpendicular, to the direction in which the cable extends. In other words, the coding on the cable sheath may have a continuous helical or continuous helical course in the direction in which the cable extends, preferably with a constant pitch, which is matched in particular to the twisting. The coding may be in the form of a recess, in particular a notch or groove, or an elevation, in particular a shoulder or bead. Electromagnetic interference may be reduced by the twisting. By twisting the conductors, induced electromagnetic fields largely cancel each other out, reducing susceptibility to interference. However, this changes the position of the conductors along the length of the cable, making contact between the contact means of the component and the conductors of the cable more difficult. By means of the coding and the defined, constant relative position of the coding to the conductors along the cable, this problem may be solved and the intended contacting between the contact means of the component and the corresponding conductors of the cable may be made possible at any point of the cable, as the coding may have a continuous course that is matched to the twisting. The various strandings or twistings may be spaced apart and/or evenly distributed in the cross-section of the cable. If the cable has a fluid line, it is preferred if the strandings are arranged evenly around the fluid line, preferably in order to ensure uniform cooling of the conductors or the strandings.

It is possible that the electrical conductors of the cable are twisted, in particular in the form of one or more twisted pairs, three-conductor twisted pairs or four-conductor twisted pairs. There may be at least two or four or six or eight or 10 electrical conductors, preferably in the form of strands, of the cable. A maximum of two or four or six or eight or 10 electrical conductors, preferably in the form of strands, can also be provided in the cable.

As already described, the at least one (or exactly one) coding of the cable can have a continuous course along the extent of the cable and/or a course that is matched to the twisting in such a way that at any point of the cable the at least one coding and the electrical conductors can have the same relative position to one another, in particular in a plane transverse, preferably perpendicular, to the direction of extension of the cable. However, without further adjustments, this may not provide any information about the orientation of the cable.

Alternatively, or additionally, the at least one (or exactly one) coding of the cable can therefore also be designed to indicate an alignment/orientation of the cable. Depending on which side of the cable a contact is made, a different orientation of the electrical conductors may have to be taken into account. In this case, simple coding such as a simple notch or marking would often only allow for an ambiguous assignment. If the coding is adapted in such a way that it also indicates the alignment and/or orientation of the cable, for example, protection against polarity reversal can be provided. The cable can, for example, be designed as a round cable. The coding can be a geometric adaptation that preferably distinguishes the cable from conventional round cables.

The coding can comprise at least one of the following adaptations and/or formations and/or additions, in order to preferably provide the alignment/orientation of the cable and/or protection against polarity reversal and/or protection against a mirror-image connection:
an asymmetrical formation,
an asymmetrical geometry,
at least one asymmetrical profile,
an, in particular asymmetrical, geometrically fixed coding,
an, in particular asymmetrical, design of the cross-section (of the cording or cable),
a further, second coding, in particular a notch, with a different design/geometry than the first coding,
a marking, preferably color marking,
a cross-sectional design that is free of rotational symmetry, preferably different from the design of the cable cross-section.

In addition to a first coding, a second coding can also be provided for indexing the alignment/orientation, which thus effects a directional indexing. The coding or one of the codings can be formed as a recess, in particular a notch or groove, or a raised part, in particular a shoulder or bead. The coding particularly prevents the cable or a device to be connected to it from being connected the wrong way around.

The cable may have a fluid line, in particular a liquid line or gas line, preferably an air line or compressed air line, whereby the at least one coding may be formed partially or only by means of the fluid line, whereby the electrical conductors, in particular the stranding or strandings, surround the fluid line along the extension of the cable, in particular uniformly, in order to preferably ensure uniform cooling of the conductors by means of the fluid, for example air, compressed air, coolant, oil or lubricant, which may be conducted through the fluid line. Preferably, the fluid line contributes to the coding by the shape of its cross-section, in particular transverse or perpendicular to the direction in which the cable extends, and/or by its position within the cable cross-section, in particular transverse or perpendicular to the direction in which the cable extends. Contributing to the coding may mean, for example, that a geometry of the cable sheath or the outer contour of the cable also contributes to the coding. In other words, a geometry of the cable sheath or the outer contour of the cable together with the fluid line, in particular the shape and/or position of the fluid line, may form the coding. Alternatively, preferably only the fluid line forms the coding by the shape of its cross-section, in particular transverse or perpendicular to the direction in which the cable extends, and/or by its position within the cable cross-section, in particular transverse or perpendicular to the direction in which the cable extends. Another object of the invention is a component, in particular an electrical component, for connection to a cable, in particular an electrical cable, preferably a cable according to the invention. The component may have at least one contact means, in particular electrical contact means, for making contact, in particular electrical contact, with at least one conductor, in particular electrical conductor, of the cable in the axial direction of the cable or conductor. Furthermore, the at least one contact means may be designed to make contact in, i.e. in particular within, the cable(s) and/or the conductor of the cable. The component according to the invention thus has the same advantages as those described in detail with reference to a cable according to the invention. In contrast to conventional solutions, the connection is simplified by the fact that the contact is not made outside the cable, e.g. by stripping the cable, but may be made inside the cable and/or the conductor. An additional step such as stripping is therefore not necessary. Accordingly, contacting in the cable may be understood as contacting within a cable sheath and/or insulation of the cable and/or in a sheath of a conductor and/or in a conductor of the cable. Contacting in the conductor may be understood to mean that the contact is made by piercing the contact means into the conductor.

It is conceivable that the component further comprises:
a counter-coding in order to specify a specific arrangement and/or assignment of the at least one electrical contact means with the at least one electrical conductor of the cable during the connection, wherein it may be possible for the counter-coding to be designed to complement a coding of the cable and/or that the counter-coding may interact with the coding of the cable and/or may be matched to the coding of the cable, and/or
the at least one contact means, which is in each case in the form of a piercing means, which is designed to be pierced into an associated electrical conductor of the cable in the form of an electrical strand in the axial direction of the cable or of the conductor, preferably to be pierced into an exposed conductor cross-section of the associated electrical conductor, and/or
a safety contact means which is designed to lead in relation to the at least one (further) contact means, and/or
in particular at least one guide pin, which is designed to provide an axial guide in the connection, preferably of the component in the cable and/or of the cable, and is preferably designed as the counter-coding, the guide pin preferably being designed to lead in relation to the at least one contact means.

The guide pin may be designed to lead by protruding further from the component than the other contact means. This means that the guide pin comes into contact with the cable before the other contact means, especially as soon as the component comes closer to a cut surface of the cable.

Furthermore, several, preferably at least three or at least four or at least five, contact means may be provided in order to electrically contact a corresponding one of the conductors of the cable. The cable may thus have the corresponding number of corresponding conductors. The conductors and/or the contact means may be arranged at different (in particular lateral) distances from one another in order to form a coding of the cable or complementary counter-coding of the component. The counter-coding may also be formed by the profile of a pin, i.e. a profile element such as a guide pin and/or a lug, of the component, which may match the cavity coding in the cable exactly.

In a further possibility, it may be provided that at least one of the contact means is designed as a safety contact means which is designed to lead in relation to at least one or all of the other contact means, preferably in order to contact one of the electrical conductors of the cable before the at least one or the other of the contact means when the connection is made. In other words, the safety contact means may be designed to lead by protruding further from the component than the other contact means. This means that the safety contact means comes into contact with the cable before the other contact means, in particular as soon as the component comes closer to a cut surface of the cable. Preferably, the safety contact means may be designed as a protective conductor and/or earthing conductor.

It is also advantageous if a sealing means is provided in order to achieve a seal between a cable sheath of the cable and the component during assembly to establish the connection. The sealing means may be, for example, a possibly elastic plastic element of the component, which at least partially surrounds the contacting and preferably cut surface of the cable after the connection.

The at least one or the multiple contact means, in particular the design and/or arrangement and/or dimensioning of the at least one or the multiple contact means, may preferably be designed for the electrical conductors, in particular the dimensioning and/or the course of the electrical conductors and/or the arrangement of the electrical conductors on the contact surface, in such a way that electrical contacting of multiple electrical conductors by means of only one of the contact means, in particular by one of the contact means electrically contacting a first electrical conductor in the contact surface and another electrical conductor in the direction of extension of the cable behind or next to the first electrical conductor, preferably due to the twisting of the electrical conductors, is excluded. In this way, incorrect contacting, i.e. unintentional contacting of several conductors by means of a single contact means, is avoided.

The component may have a strain relief for the cable, which is designed to interact with one of the contours, in particular with one of the strain relief contours, of the cable, preferably in the form of a circumferential recess, in particular groove or notch, or elevations, or elevation, in particular bead or shoulder, in such a way that the cable is strain-relieved and/or that the component may have a heat-shrink tubing and a fastening, preferably in the form of a fastening contour, for the heat-shrink tubing in order to form the strain relief for the cable, in particular by means of the heat-shrink tubing. Preferably, the strain relief is designed in such a way that the strain relief pretensions the cable against the component, preferably in the direction of extension of the cable and/or in the direction of contacting. Furthermore, it may be preferred that the strain relief is designed to engage in the recess or to engage behind the elevation, in particular as seen from the component. In other words, the strain relief may engage behind the elevation. Furthermore, the strain relief may comprise gripping arms for engaging or gripping behind. The strain relief may be formed of plastic and/or integral with the component. The strain relief may also be adjustable, so that a pretension of the cable against the component may be adjusted. The pretension may be adjustable in steps or continuously. Preferably, the strain relief may be designed in such a way that it establishes a strain-relieving connection with the strain relief contour during the contacting movement to establish the electrical connection between the cable and the component.

The component may, in particular in areas for contact with the outer circumference and/or the contact surface of the cable, have a microencapsulation for forming a seal, wherein the content of the microencapsulation may be released in particular by the supply of heat, radiation, in particular the supply of light, preferably in the form of ultraviolet light or ultraviolet radiation, contact with an activation substance or the supply of light in combination with moisture, or wherein the component, in particular in areas for contact with the outer circumference and/or the contact surface of the cable, may have an activation substance for a microencapsulation in order to release its contents on contact with a microencapsulation. Alternatively or vice versa, the component may have an activation substance for a microencapsulation or the microencapsulation, in particular in areas of contact with the outer circumference and/or the contact surface of the cable, in order to release the contents of a microencapsulation on contact with the microencapsulation. The details given for the cable, in particular for the microencapsulation and the activation substance, may also apply to the component.

The contact means may lead electrically to electrical contact conductors of a plug assembly or socket assembly of the component, whereby the position and/or arrangement and/or assignment and/or dimensioning of the electrical contact conductors differs from that of the contact means, in particular on the contact surface. Preferably, a plug with such a plug assembly or a socket with such a socket assembly may be formed on the component. The course of the guide from the contact means to the contact conductors of the plug or the socket may preferably not be straight, but at least at one point of the course angled, preferably vertical, or curved, whereby the plug or the socket is formed on a side of the component that runs transverse or perpendicular to the insertion direction of the cable or to the contacting direction. The plug may be designed to establish an electrical and/or form-fitting connection with a socket. The socket may be designed to establish an electrical and/or form-fitting connection with a plug. Alternatively, the plug or the socket may be formed on a side of the component that faces away from the side of the component on which the cable may make electrical contact with the contact means. In addition, the course of the guide from the contact means to the contact conductors of the plug or socket is designed in such a way that the arrangement and/or assignment of the electrical conductors of the plug or socket differs from that of the contact means. For example, an electrical connection may be made from a small cable cross-section of a cable to a large plug assembly or socket assembly. Preferably, at least two contact conductors of the socket assembly or the plug assembly have a greater or smaller distance to each other than the electrical conductors of the cable have to each other in the cable cross-section.

The component may have a fluid channel for fluid-transmitting connection to the fluid line of the cable, in particular in order to form a, preferably fluid-tight, transition from the fluid line of the cable to the fluid channel of the component. The fluid channel of the component may be designed as a counter-coding to the coding of the cable, which is preferably designed as a fluid line. In this way, for example, further coding may be dispensed with.

It may be provided within the scope of the invention that the component is designed as a plug or a sensor or an actuator or a module, e.g. a fieldbus module, preferably for use in industrial automation, preferably in an electrical plant for industrial automation. The fieldbus module is used, for example, to transmit data and/or receive control commands via a fieldbus and to be connected to at least one device such as a sensor and/or actuator in order to read out the sensor and/or control the actuator.

The cable according to the invention may further be designed as an Ethernet cable, preferably a Single Pair Ethernet (SPE) cable. The cable may also be provided as a power and/or signal and/or data cable and/or fieldbus cable and/or hybrid cable, i.e. preferably also a combination of the aforementioned cables. In particular, it is possible for the cable to be a combination of data and energy cable, in which electrical energy may be transmitted in addition to data. For example, the hybrid cable may combine at least fieldbus lines and power lines (e.g. 24 V). It is conceivable that, in addition to electrical signals such as energy and data, other media such as air or liquids may also be transmitted through the cable. Furthermore, the maximum cable length of the cable may exceed 100 m. The cable may provide a simple connection technology that may be used in the field, in which the cable may be unwound from a cable drum and cut to the required length, for example. Due to the structure described and in particular the coding, the cable may be plugged directly after cutting without further measures such as crimping. A sealing means may also be used to provide an automatic seal and strain relief. The strain relief may optionally also be provided by a mechanical locking mechanism which, for example, cuts into the cable sheath with a form-fitting fit and/or has a force-locking clamping mechanism when closing.

Another object of the invention may be a connection system comprising a cable according to the invention and a component according to the invention. The cable and the component may be electrically connected to one another, in particular by the contact means being pierced into the electrical conductors at the contact surface.

An electrical connection may be established between the cable and the component, in particular by the contact means being pierced into associated conductors, the connection system comprising a seal, in particular a material-locking and/or force-locking and/or form-fitting seal which seals the connection and in particular a cable section adjacent to the connection from an environment of the connection system, in particular in accordance with IP20 or IP67, wherein the seal may preferably, in particular in the case of a form-fit seal, be formed by means of a heat-shrink tubing or the heat-shrink tubing forming the strain relief. A form-fit seal of this kind may be created using heat-shrink tubing, for example. IP20 may be a protection and/or certification that states that the ingress of foreign bodies is prevented. IP67 may be a protection and/or certification that states that there is protection against dust and submersion in water up to a maximum depth of 1 meter for a maximum of 30 minutes. Preferably, IP20 and IP67 refer to the protection classes and/or certifications as they were valid on 27.09.2024, in particular in the Federal Republic of Germany.

The seal may seal and/or electrically insulate a transition from the fluid line to the fluid channel in a fluid-tight manner with respect to the contact points, which are formed by means of contactings of the conductors with the contact means on the contact surface, and/or wherein the seal electrically insulates and/or seals the contact points, which are formed by means of contactings of the conductors with the contact means on the contact surface, with respect to each other. In this way, leakage of the fluid or a malfunction is prevented.

The, in particular form-fit, seal may preferably be formed by means of a heat-shrink tubing, whereby the heat-shrink tubing is preferably formed as a or the strain relief of the cable, in that the heat-shrink tubing forms a form-fitting fit, in particular with a strain relief contour of the cable, preferably in that the heat-shrink tubing engages behind the strain relief contour or engages in the strain relief contour, and is attached to the component by means of an attachment of the component, in particular an attachment contour of the component, and thus preferably forms a pretension of the cable against the component. Alternatively, it is conceivable that the heat-shrink tubing only serves as a seal.

The seal may be formed by means of a sealing compound, in particular adhesive or casting compound, whereby, in particular in the direction of extension of the cable and/or perpendicular to the direction of extension of the cable, a sealing chamber may be formed between the cable, in particular the contact surface of the cable, and the component for receiving the sealing compound, in which the sealing compound is located and preferably completely fills the sealing chamber, wherein the sealing chamber may preferably have a filler opening for the sealing compound, which may in particular be closed by the sealing compound, wherein the sealing chamber may preferably have an outlet opening for the sealing compound, which may in particular be closed by the sealing compound, wherein in particular a section of the component delimiting the sealing chamber may be formed from a transparent material so that the degree to which the sealing chamber is filled with the sealing compound may be determined optically. The sealing compound may be filled into the sealed chamber in a liquid state by means of the filler opening. By means of the outlet opening, excess sealing compound filled in may escape from the sealed chamber in a liquid state, making it possible to determine whether the sealing compound has been evenly distributed in the sealed chamber. The sealing compound is preferably curable and/or electrically insulating. Closing the openings with the sealing compound may prevent foreign bodies or moisture from entering the sealed chamber.

The seal may be formed by means of a released content of the microencapsulation, in particular of the cable or the component. The contents of the microencapsulation may preferably have been released by means of heat supply, radiation, in particular light supply, preferably in the form of ultraviolet light, contact with an activation substance or light supply in combination with moisture.

The cable may be attached to the component by means of a force-fit and/or form-fit and/or material-fit connection. For example, a screw connection or a clamp connection or a snap-in connection may be provided for this purpose. The strain relief may also be provided and/or dimensioned and/or designed for this purpose.

The component may have a strain relief, in particular a heat-shrink tubing designed as a strain relief, which may preferably be attached to the component, for the cable, whereby the strain relief may interact with one of the contours, in particular one of the strain relief contours, of the cable in such a way that the cable is strain-relieved by the strain relief forming a positive fit, in particular with the contour, in particular the strain relief contour, of the cable, that the cable is strain-relieved by the strain relief forming a form-fit in particular with the contour, in particular the strain relief contour, of the cable, preferably by the strain relief engaging behind the contour, in particular the strain relief contour, or engaging in the strain relief contour.

The connection system may comprise an insertion mechanism, in particular a screw mechanism, a lever mechanism or a plug-in mechanism, to perform the contacting movement, the insertion mechanism preferably being designed to move the cable towards the component during the contacting movement, the connection system or the insertion mechanism preferably comprising an adjusting mechanism, to adjust a predetermined depth of penetration of the contact means into the conductor at the insertion mechanism, preferably depending on a cable type of the cable and/or continuously and/or in several predefined steps, wherein the connection system or the insertion mechanism preferably comprises an indexing or indexing device which is adapted to index the current depth of penetration for a user during the contacting movement.

Preferably, the screw mechanism is designed as a union nut or comprises a union nut that establishes the electrical connection when screwed to the component. A lever of the lever mechanism may preferably be mounted on the component. Actuation of the lever may cause the contacting movement. Preferably, the component comprises a thread, for example an M8 or M12 thread, preferably as an external thread, and the union nut comprises a mating thread, preferably an internal thread.

The insertion mechanism may include a gripper, for example. The insertion mechanism or gripper may be part of the component, attached to the component or separate to the component. The gripper may grip the cable or a cable end section, preferably by the cable or cable end section being clamped or held by the gripper. Preferably, the gripper interacts with the strain relief contour and/or the coding of the cable for this purpose, preferably by the gripper gripping behind the raised portion or engaging in the recess. Preferably, the gripper has the counter-coding. In other words, the cable may only be gripped in the intended orientation by means of the gripper in order to establish an intended electrical connection between the cable and the component, in particular between the electrical conductors of the cable and the contact means of the component.

Preferably, the insertion mechanism may be used not only to establish the electrical connection, but also to establish the necessary surface pressure for a sealing element, in particular an elastomer seal, on the component. The seal may be arranged in such a way that it is in physical contact with the contact surface when the electrical connection is made. The seal may have been produced by means of a multi-component injection molding process during the manufacture of the component. The seal may seal the transition and/or the fluid conduit and/or the fluid channel from the contact points, between the electrical conductors and the contact means, and/or seal the contact surface from an environment of the connection system. By means of the insertion mechanism, the cable, which is held and/or retainable by the gripper, may be moved towards the component, preferably to establish the electrical connection between the cable and the component, in particular between the electrical conductors of the cable and the contact means. The insertion mechanism is designed such that the contact means may only be contacted by piercing the electrical conductors of the cable at the contact surface.

The indexing may be designed as a scale or as acoustic and/or haptic feedback for the user. For example, latching noises of a latching mechanism due to the contacting movement may trigger such acoustic feedback. It is also conceivable that engagements of a or the engagement mechanism during the contacting movement generate the haptic feedback. The scale may be formed on the component for this purpose, while preferably the insertion mechanism, in particular the screw mechanism, lever mechanism or plug-in mechanism, may act as a pointer to the scale.

The adjusting mechanism may be designed as an adjustable movement limiter for the insertion mechanism, in particular a screw mechanism, lever mechanism or plug-in mechanism, which preferably limits the maximum depth of penetration or the maximum depth of piercing of the contact means into the conductor. The adjusting mechanism may, for example, be adjustable by means of a screw or a union nut and/or rotary movement.

Preferably, the insertion mechanism has a motion converter, which may be designed in such a way that an actuating movement, in particular pressure movement or rotary movement or swivel movement, is converted or may be converted into a contacting movement.

In principle, two interacting codings may be referred to as coding and counter-coding.

The cable and/or the component and/or the connection system may be designed for Single Pair Ethernet (SPE) and/or have only one wire pair/conductor pair. In contrast to conventional Ethernet, which usually has four wire pairs or conductor pairs per cable, SPE reduces the need for cables, resulting in compact and cost-effective connections. Such a cable preferably has only one pair of wires or only one pair of conductors. The cable may preferably comprise a twisting of the pair of wires or the pair of conductors. The single wire or conductor pair may be designed to transmit data as well as electrical current or voltage, preferably over distances of up to 1000 meters and/or at a maximum data transmission speed of 10 Mbps, 100 Mbps or 1 Gbps. Furthermore, the cable may be designed to supply an end device with electrical current or voltage in accordance with Power over Data Line (PoDL) and transmit data at the same time. Preferably, the cable and/or the component and/or the connection system may be used or be suitable for use in Industry 4.0, Internet of Things (IoT), the automotive industry or building automation applications. The conductor pair or the wire pair preferably comprises or consists of copper or a copper alloy. Preferably, the cable corresponds to a single pair Ethernet cable according to IEEE 802.3bw, preferably in the validity of this standard on 27.09.2024, in particular in the Federal Republic of Germany. Preferably, the cable may be designed for full-duplex communication.

The component may preferably be a Single Pair Ethernet plug connector (SPE plug connector), in particular in accordance with the IEC 63171 standard, preferably in accordance with the status of 27.09.2024, in particular with effect for the Federal Republic of Germany. Particularly preferably, the component may be designed as a plug connector or circular plug connector with an M8 or M12 thread. The plug assembly or the socket assembly of such a plug connector may have a thread for attachment, in particular to an electrical device or sensor. Furthermore, the cable and/or the component and/or the connection system may be designed to transmit a maximum power of 50 or 60 watts.

In principle, it is preferred for conductors to be the conductors of the cable, unless otherwise specified. In other words, they may preferably only be conductors of the plug assembly or socket assembly if it is explicitly stated that they are the conductors of the plug assembly or socket assembly.

The connection system according to the invention may have a strain relief that ensures that the connection between the cable and the component is not accidentally disconnected, in particular that the component is not accidentally pulled out of the cable. The strain relief may be provided by a mechanical locking mechanism which, when the connection is made, cuts into the cable sheath of the cable with a positive fit and/or provides a force-fit clamping with the cable sheath and/or the conductors of the cable. This holds the cable firmly to the component and prevents unintentional disconnection. Accordingly, strain relief may be provided as a function or device of the connection system that serves to fix and protect the cable with the component and prevent the cable connection from being damaged by tensile loads.

If the connection needs to be released again, this may be done using an unlocking mechanism-preferably without tools. The connection technology required for this on the component side may, for example, be integrated directly on a printed circuit board of the component or in a plug of the component. It is also possible for the tool-free unlocking mechanism to be actuated by a simple hand movement, which further simplifies operation of the component. For this purpose, the tool-free unlocking mechanism may have, for example, an unlocking tab or an unlocking button, which is provided or formed on the housing of the component to enable easy unlocking without tools. The locking mechanism may be realized by a latching device, which is activated by a rotation or pressure on a certain area of the component. The latching device may have one or more latching lugs that engage in corresponding recesses or cut-outs. The unlocking mechanism may then be realized by an unlocking button or an unlocking lever, which releases the latching device by a simple actuation and releases the connection. Alternatively, the release mechanism may be realized by a strain relief that is released by a simple twist or pressure on a specific point of the cable or component. This releases the connection and the cable may be removed.

Furthermore, the connection system and in particular the component may have a large number of contact means that establish an electrical connection between the conductors of the cable and electrical contacts of the component. The electrical contacts are used, for example, to transfer energy and/or data to a device such as a sensor or actuator, to which the component may be connected for this purpose. The contact means may be designed as plug contacts and/or needles or other suitable connecting elements. The connection system may also have a protective device that protects the contact means from damage caused by external influences such as dust, dirt or moisture. A protective cap, seal or other suitable protective device may be provided for this purpose, which shields the contact means from harmful environmental influences.

Furthermore, the at least one or the multiple contact means of the component may be designed to be inserted, preferably pierced, in each case on and/or through an exposed conductor cross-section of an associated conductor of the cable. The respective conductor with its exposed conductor cross-section and the preferably pierced contact means inserted therein may be at least partially surrounded by an insulating sheath and in this way form a conductor, preferably a stranded conductor. For contacting purposes, the cable may be designed to provide a contact surface after cutting, in which the conductor cross-section is exposed, preferably completely.

Furthermore, all or at least one or at least two of the conductors or lines of the cable may be surrounded by at least one shield, in particular individually or in pairs. The pairwise shielding of wire pairs within the cable is particularly useful for hybrid cables and/or for the data lines.

The shielding may then be contacted, for example, by means of a contact surface of the component that dips axially into the cable. This may have the advantage that a higher transmission reliability and a lower electromagnetic interference of the individual conductors may be achieved. It is possible that a shielding of the conductors or lines of the cable is made of a conductive material such as copper or aluminum. This ensures high conductivity and effective shielding against external interference.

One preferred option for contacting the shielding is to use a contact surface that penetrates axially into the cable and thus ensures an effective connection with the shielding. For this purpose, the contact surface may be designed as a conductive coating on the component, for example, in order to establish a direct connection with the shielding in this way. Alternatively, the contact surface may also be designed as a separate unit that is inserted into the component and then connected to the shielding. It is also possible to design the contact surface as a spring contact that pushes through the shielding and thus establishes a reliable connection. The spring contact is attached to the housing, for example, and may therefore be pressed through an opening in the shielding to establish a reliable connection. The shielding may extend over the entire length of the cable or only over certain sections, depending on the requirements of the application. It is also possible for the shielding to consist of several layers to achieve an even higher level of shielding.

The cable may be used, for example, for industrial automation, e.g. to control tensioning devices or as a drag chain cable for drag chains. In particular, cables may therefore be used that are suitable for withstanding high mechanical loads and have a high degree of flexibility in order to meet the requirements of industrial automation. They must also be highly resistant to environmental influences such as moisture, oil and chemicals in order to ensure reliable control of pneumatic tensioning devices or, in the case of drag chains, as drag chain cables. Examples of this are Cables made of polyurethane (PUR), polyvinyl chloride (PVC), ethylene propylene diene monomer (EPDM) or polyolefin (PO).

Another object of the invention is a connection system comprising a cable, in particular an electrical cable and/or cable according to the invention, and a component, in particular an electrical component and/or component according to the invention. The connection system according to the invention thus has the same advantages as those described in detail with reference to an electrical cable according to the invention and a component according to the invention.

Another object of the invention is a method for making electrical contact between a cable, in particular an electrical cable and/or cable according to the invention, and a component, in particular an electrical component and/or component according to the invention. The method may comprise unwinding and/or assembling and/or cutting the cable to a desired length. This may result in a contacting and, in particular, cut surface of the cable at which at least one conductor of the cable becomes accessible for contacting. Furthermore, the method may comprise establishing a direct connection between the component and the cable, whereby the connection may be established directly between at least one contact means of the component and an associated conductor of the cable, and/or whereby the component (at least parts of the component such as the contact means) is directly inserted and/or pierced into the cable or vice versa in order to establish an electrical and/or mechanical contact. For example, the contact means may be pierced into an associated conductor and preferably into an exposed conductor cross-section of the conductor of the cable. The method according to the invention thus has the same advantages as those described in detail with reference to a cable and a component according to the invention. Due to the simple assembly of the cable, the effort required for its use may be reduced. It may also prevent the formation of loops and save material.

According to an advantageous further development of the invention, it may be provided that a mechanical seal between the cable and the component is also created at least partially or exclusively by making the connection. For this purpose, the component may have a sealing means which is transferred directly into the correct position for sealing by the mechanical connection without further measures. The sealing means may, for example, comprise a wall and/or a sealing lip. The sealing means may comprise a wall and/or a sealing lip and is transferred directly into the correct position to the seal by the mechanical connection without further measures in order to reliably seal a contact surface of the cable. For this purpose, the sealing means encloses the contact surface of the cable in this position, for example along the circumference.

### BRIEF DESCRIPTION OF THE SEVERAL VIEWS OF THE DRAWINGS

Further advantages, features and details of the invention are apparent from the following description, in which embodiments of the invention are described in detail with reference to the drawings. The features mentioned in the claims and in the description may be essential to the invention individually or in any combination. The drawings showing:

FIG. 1 Variants of cables and components according to embodiments of the invention, each in a sectional view.

FIG. 2 Parts of components according to embodiments of the invention, each in a sectional view.

FIG. 3 Various conductors of cables according to embodiments of the invention, each in a perspective view.

FIG. 4 a perspective view of a contacting or cut surface of cables according to embodiments of the invention.

FIG. 5 a perspective view of a contacting side of components according to embodiments of the invention.

FIG. 6 a perspective view of a component according to embodiments of the invention.

FIG. 7 a perspective view of a component according to embodiments of the invention.

FIG. 8 a sectional view of a cable and a component connected thereto according to embodiments of the invention.

FIG. 9 a perspective view of a contacting or cut surface of a cable according to embodiments of the invention.

FIG. 10 a top view of a cable according to embodiments of the invention.

FIG. 11 a method according to embodiments of the invention.

FIG. 12 a perspective view of a guide device according to embodiments of the invention.

FIG. 13A perspective view of a cable according to embodiments of the invention.

FIG. 14A further perspective view of a cable according to embodiments of the invention.

FIG. 15A schematic representation of an insertion mechanism according to embodiments of the invention.

FIG. 16A further schematic representation of parts of an insertion mechanism according to embodiments of the invention.

FIG. 17 Another schematic representation of an embodiment of a connection system.

FIG. 18a Another schematic representation of an embodiment of a component.

FIG. 18b Another schematic representation of an embodiment of a component.

FIG. 19a Another schematic representation of an embodiment of a connection system with a seal.

FIG. 19b Another schematic representation of an embodiment of a connection system with a seal.

FIG. 19c Another schematic representation of an embodiment of a connection system with a seal.

### DESCRIPTION OF SPECIFIC EMBODIMENTS OF THE INVENTION

In the following figures, the identical reference symbols are used for the same technical features, even for different embodiments.

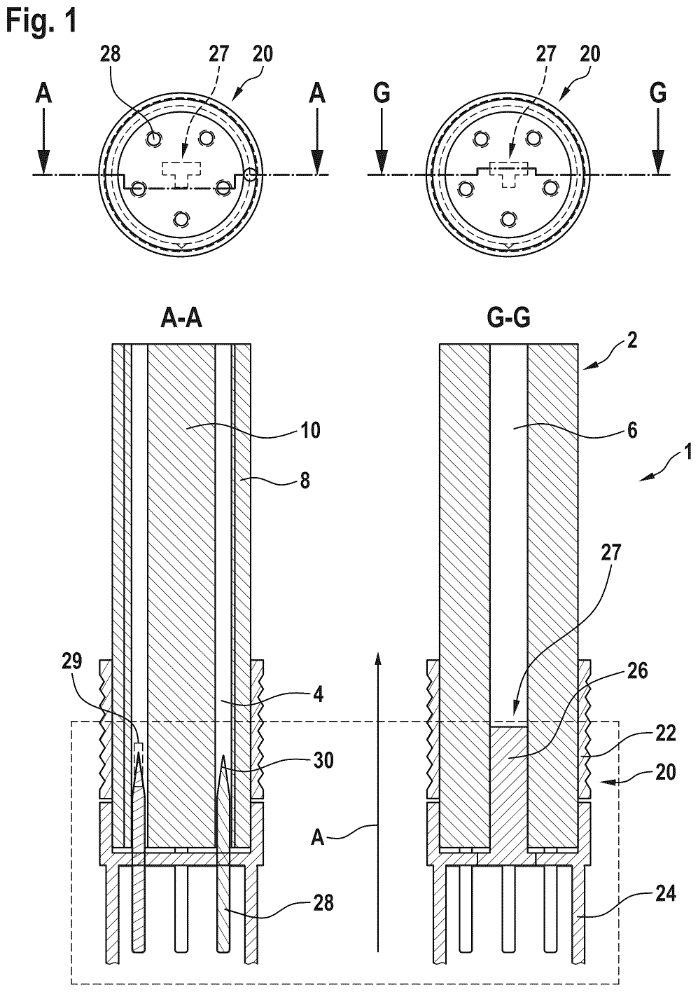

FIGS. 1 to 10 schematically illustrate embodiments of the invention. Specifically, variants of an electrical cable 2 are shown, which is used to connect to an electrical component 20. The cable 2 may have at least one electrical conductor 4 for this purpose. Furthermore, a connection system 1 according to embodiments of the invention is illustrated, which may comprise the cable 2 and the component 20. The sectional planes A-A and G-G are marked in the various views.

In FIG. 1, the cable 2 is shown in a state in which it is fully electrically and mechanically connected to the component 20. It may be seen that, in this state, the contact means 28 are inserted into the cable 20 and, in particular, into the electrical conductors 4 of the cable 20 in order to establish a secure mechanical and electrical contact. Clearly visible here, the contact means 28 have a tip 30 in order to be pierced into the conductors 4. The component 20 is designed here as a plug connector, possibly with a threaded screw connection arranged in the area 24, in order to be attached to a connection of a device such as a fieldbus module, actuator or sensor. This allows the cable 2 to be connected to the device for transmitting electrical energy and/or data via the plug connector.

In contrast to conventional solutions, the design of the cable 2 may significantly simplify the connection between component 20 and cable 2. For this purpose, structural additions may be made to the cable 2, such as, for example, at least one coding 50 formed spatially on the cable 2. In FIG. 1 it may be seen that the cable 2 has at least one cavity 6, which serves to form the at least one coding 50 on the cable 2 as further illustrated in FIG. 9 (see, for example, FIG. 9). Such a coding 50 may also be provided on the component 20 and then in particular be referred to as counter-coding 27 if this is formed complementary to the coding 50 on the cable 2. The coding of the cavity 6 means that a correspondingly counter-coded pin 26, preferably guide pin 26, may only be inserted into the cavity 6 as guide means 26 if the orientation of the component 20 relative to the cable 2 is correct (i.e. according to a lock-and-key principle). Otherwise, the insertion of the pin 26 into the cavity 6 may be prevented by other parts of the cable 2. This may then also block the establishment of the connection between cable 2 and component 20. The coding 50 on the cable 2 may thus specify a specific arrangement and assignment of electrical contact means 28 of the component 20 with the electrical conductors 4 of the cable 2.

The at least one coding 50 may comprise a mechanical and/or geometric coding 50 of the cable 2, in which a geometric profile 7 extends in the axial direction A of the cable 2. In FIG. 1 and FIG. 9, the profile 7 may be provided by a t-shaped opening of the cavity 6 on the cable 2 and a corresponding t-shaped counter-coding 27 may be provided on the component 20. The cavity 6 may also be designed to transmit a fluid, preferably a medium such as air or a liquid. In addition to a t-shaped coding, an L- or Y-coding or other forms are also conceivable.

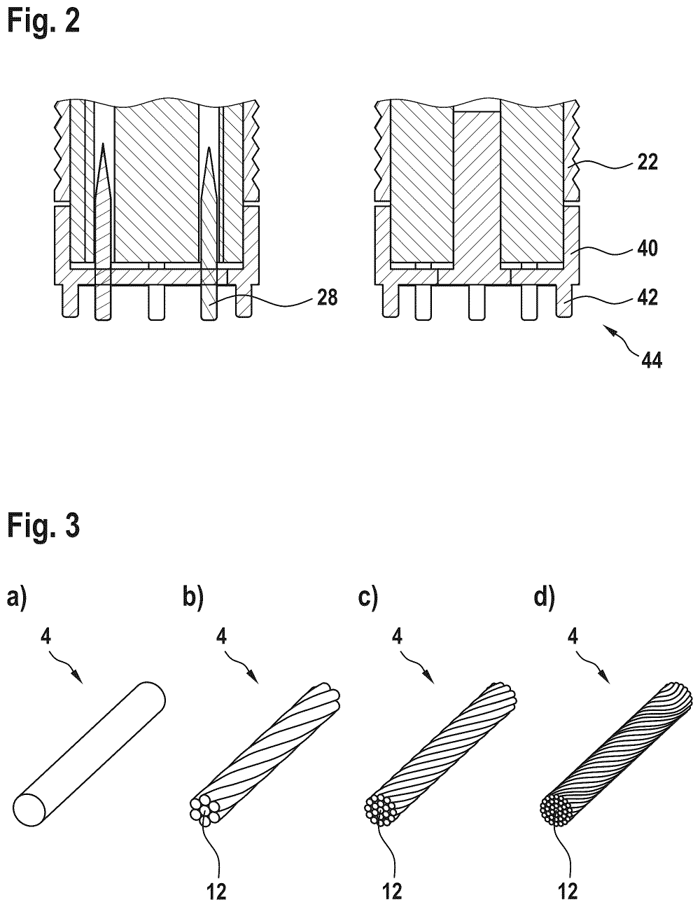

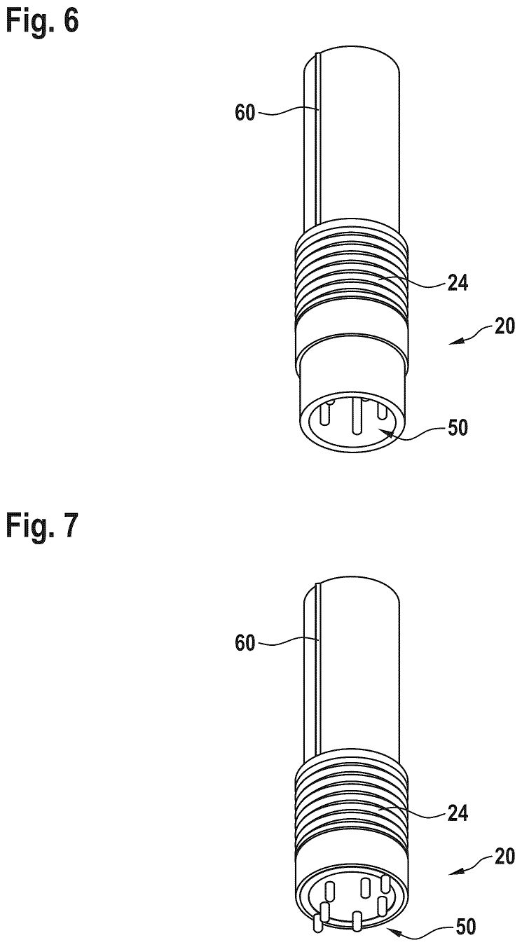

FIG. 2 shows an embodiment of the component 20 in the form of a plug connector, in which a protruding wall 40 is provided for connector assembly 40 (see also FIGS. 6 and 7). The wall 40 may, for example, be attached to a printed circuit board 42 of the component 20 in order to provide a locking device and/or anti-twist protection and/or a seal 44 on the cable 2. This wall 40 may optionally have a locking mechanism 22 to enable secure attachment to the cable 2.

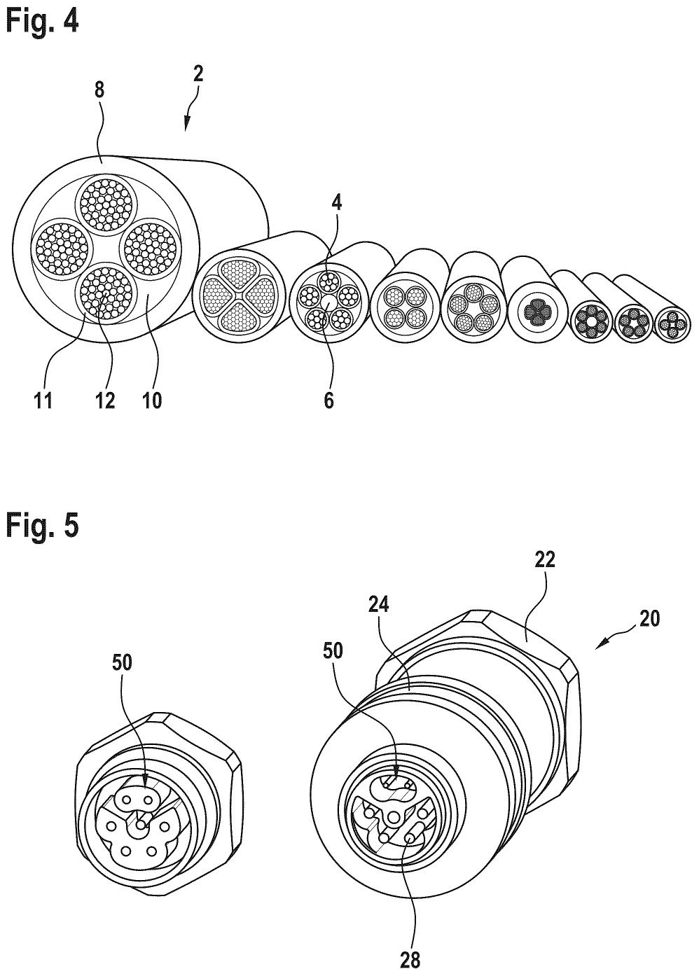

FIGS. 3 and 4 further illustrate that the cable may have the multiple conductors 4 in the form of strands, also referred to as stranded conductors. Each of these stranded conductors may have several fine, twisted wires 12, which may be surrounded by an insulating layer (insulation) recognizable in FIG. 4. This insulation is made, for example, from materials such as polyethylene or polyvinyl chloride. It may serve to insulate the conductors 4 both from each other and from the external environment. In addition, the insulation may often be color-coded to make it easier to identify and wire. In order to minimize electromagnetic interference, a shield made of a metal mesh or metal foil may be provided around the insulated conductors 4 as filling material 10. Furthermore, an additional inner sheath may be placed around the shielding to increase the mechanical stability of the cable 2. Furthermore, the entire cable 2 may have a robust outer sheath 8, which is preferably made of materials such as PVC, PE or thermoplastic elastomer and may have special properties such as flame resistance or oil resistance. This multi-layered structure allows the cable 2 to be highly flexible and robust, making it suitable for a wide range of applications.

In further optional designs of the cable 2, the conductors may be highly flexible and provided with 360° full shielding. This full shielding serves to effectively shield electromagnetic interference (EMC) and thus ensure the integrity of the data transmission. Other optional versions include overmoulded versions of the cable 2 with highly resistant PUR overmoulding, which are specially designed for use in harsh environments. The cables may be designed to be self-assembled, i.e. assembled in the field (on site at the system). In particular, this means that the cables themselves have the structural adaptations that allow them to be connected and disconnected quickly and easily and adapted to a desired length. In this way, the cables may be quickly adapted or replaced as required without the need for special tools or specialist knowledge.

The electrical conductor 4 may be made of copper or aluminum, for example. Other materials such as gold, silver, carbon fiber and conductive polymers may also be used as a component of the conductor 4, depending on the application. In addition, composite materials made from various of these elements may also be used in specialized applications in order to optimize specific properties such as conductivity, weight and corrosion resistance.

Further, the at least one coding 50 may comprise a geometric and/or extruded profile 7 of the cable 2 and/or a conduit (not explicitly shown) and/or a grommet. The at least one coding 50 may further comprise an electrical coding 50 of the cable 2, in which a systematic arrangement of the electrical conductors 4 of the cable 2 is provided, so that a specific assignment of the electrical contact means 28 of the component 20 is predetermined for the connection. In FIG. 5, a corresponding coding 50 is illustrated, in which the contact means 28 of the component 20 are arranged in a corresponding manner with different lateral spacings.

In FIGS. 1, 2 and 5-8, a component 20 for connection to an electrical cable 2 is shown schematically. The component may have at least one electrical contact means 28 for making electrical contact with at least one electrical conductor 4 of the cable 2 in an axial direction A of the cable 2 or conductor 4. The axial direction A, or longitudinal direction of the cable 2, is illustrated in FIG. 1 by a vertical arrow. Furthermore, the at least one electrical contact means 28 may be designed to make the electrical contact in the electrical cable 2—i.e. in particular within the cable 2 and/or sheath 8.

FIGS. 6 and 7 further illustrate that a further structure such as a locking and/or orientation structure 60 may be provided, for example, to further simplify the correct alignment of the component 20 relative to the cable 2 during the connection. The structure 60 is formed, for example, as a groove or material recess on the component 20 and/or on the cable 2.

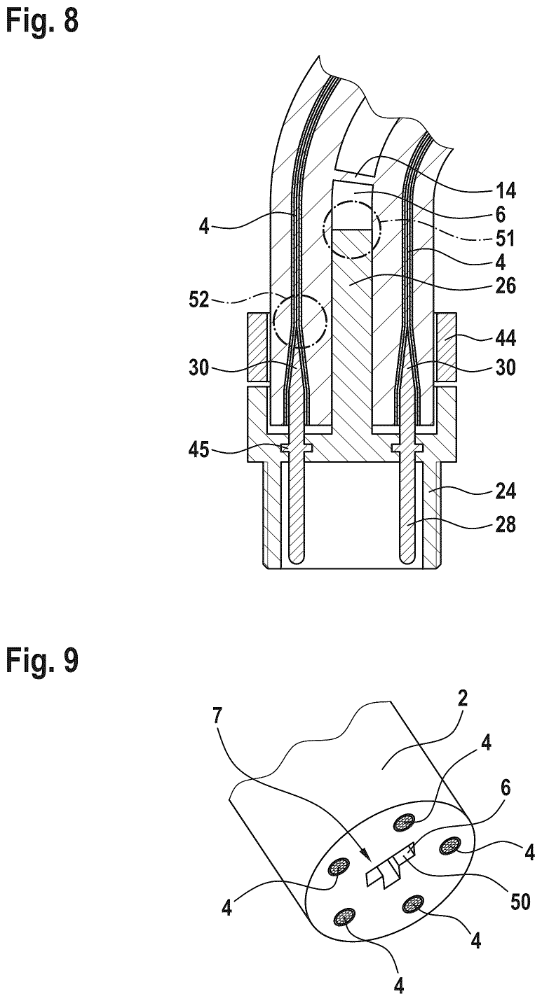

FIG. 8 shows that the cavity 6 of the cable 2 may also be interrupted by a connecting part 14. This connecting part 14 may repeatedly interrupt the cavity 6 in the axial direction A of the cable 2. In particular, it serves as a sealing for condensate. This has the advantage that moisture is prevented from penetrating the cable 2, thus ensuring that it remains functional. Accordingly, the connecting part 14 may also serve as a sealing element.

Furthermore, a locking pin 45 is shown in FIG. 8, which may be provided on the contact means 28 in order to fix the position on the cable 2 after the connection has been made. More generally formulated, a locking device 45 may be provided on the component 20 or on the cable 2 in order to fix the established connection.

It is further illustrated in FIGS. 8 and 9 that the coding 50 may comprise a first coding 51, which is provided by the shape of the cavity 6. This refers in particular to the shape of the opening of the cavity 6 with the profile 7 recognizable in FIG. 9. Alternatively or additionally, a second coding 52 may be provided, which is provided by the arrangement and/or formation of the conductors 4. In particular, the coding may be provided here by the formation of the strand 4 to the tip 30 of the contact means 28 or, conversely, the counter-coding may be provided by the formation of the tip 30 of the contact means 28 to the strand 4. Due to the tip 30, the contact means 28 may be designed accordingly as a needle, which then penetrates a conductor cross-section 5 of the conductor 4 for contacting during the connection (see FIG. 13). Different lengths of the contact means 28 may also be provided for a leading, e.g. of a safety contact means 29.

FIG. 8 further shows that the component 20 may comprise the at least one contact means 28 in the form of a piercing means, which is designed to be pierced into an electrical conductor 4 of the cable 2 in the form of an electrical strand 4 in the axial direction A of the cable 2 or the conductor 4. The bending apart of the single wires of the strand 4 at the pin tip 30 is illustrated in FIG. 8.

In FIG. 1 it is further illustrated by a dashed line that at least one of the contact means 28 may be designed as a safety contact means 29, which is designed to lead with regard to at least one or all of the other contact means 28. This allows the safety contact means 29 to contact one of the electrical conductors 4 of the cable 2 before the at least one or the other of the contact means 28 when the connection is made, i.e. during a contacting movement.

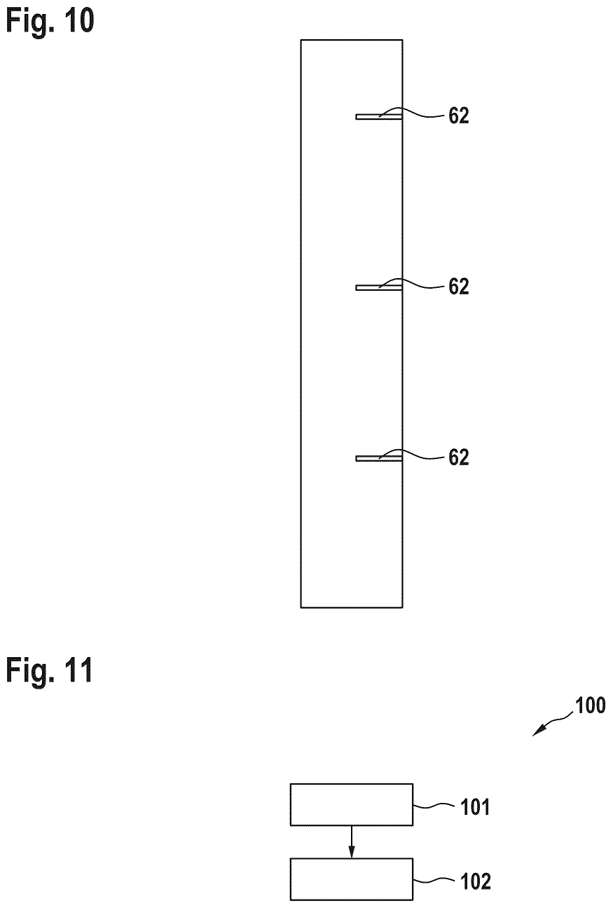

FIG. 10 shows that (e.g. every 5 mm) a recurring marking 62 may be provided on the cable 2, which indicates a depth of penetration of the electrical contact means 28, preferably in the form of piercing means. This marking 62 may be printed on, for example. The marking 62 may, for example, be provided in the form of a line or dot. The marking 62 may also be a mechanical marking which, for example, interacts with an insertion mechanism 80.

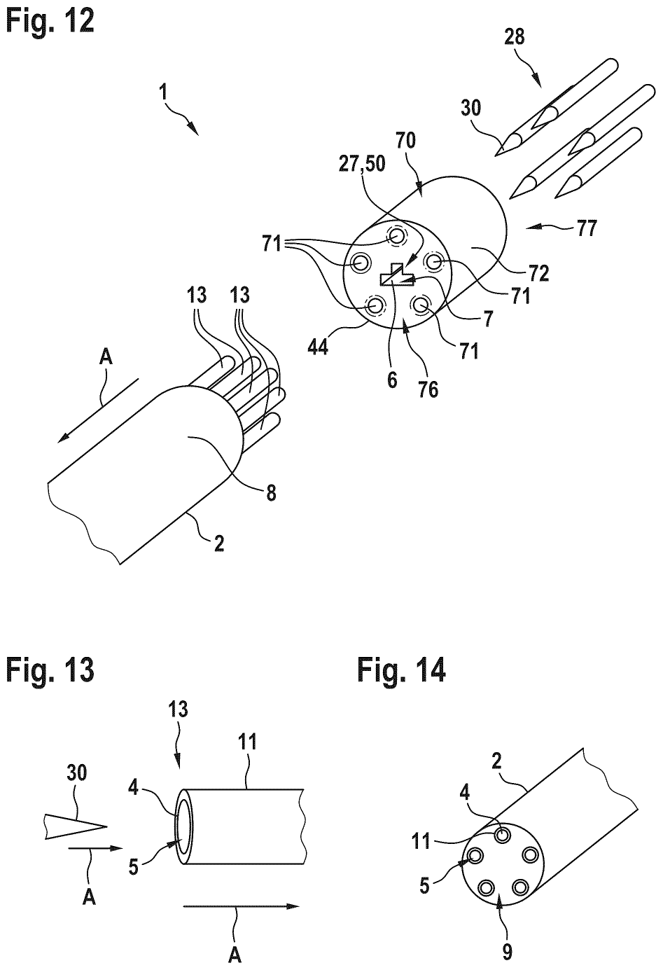

In FIG. 12, according to further embodiments of the invention, a connection system 1 with a component 20 and a cable 2 may be seen. The component 20 may be provided for connection to an electrical cable 2. For this purpose, the component 20 may comprise a plurality of contact means 28 for making contact with conductors 4 of the cable 2. In the electrical cable 2 shown, the conductors 4 may be accessible from the outside for contacting with the contact means 28. In FIG. 12, the conductors 4 are surrounded by an insulating sheath 11 and are thus part of lines 13, specifically stranded lines 13 (see FIG. 13). Both the contact means 28 and the conductors 4 are electrically conductive here. Furthermore, the conductors 4 may each have an exposed conductor cross-section 5 for contacting (see FIGS. 13 and 14).

The connection system 1 may be designed for contacting the contact means 28 with the conductors 4 in axial direction A of the cable 2 or conductor 4 in order to electrically connect the contact means 28 directly to the exposed conductor cross-sections 5. For this purpose, as illustrated in FIG. 13, the contact means 28 may each have a tip 30 and/or be needle-shaped. In other words, the conductors 4 may be contacted by piercing the contact means 28 through the exposed conductor cross-sections 5 in axial direction A.

In FIGS. 12 to 14, among others, a contact surface 9 is provided on the cable 2, at which the conductors 4 are accessible for contacting with the contact means 28. Specifically, the contact surface 9 may lie in a cut plane of the cable 2, which is created, for example, by cutting the cable 2 at this point. It may be seen that the conductors 4 there may be adjacent to the outside from an interior of the cable 2 (see FIGS. 13 and 14) or protrude (see FIG. 12) and are thus visible and accessible from outside the cable 2. In FIGS. 13 and 14, the respective exposed conductor cross-section 5 also lies in the sectional plane.

According to FIG. 13, the conductors 4 may each form a line 13 with a surrounding insulating sheath 11, whereby the lines 13 protrude from the contact surface 9 (see FIG. 12) or are flush with it (FIGS. 13 and 14). Furthermore, the solution according to embodiments of the invention may avoid stripping, so that the protruding conductors 4 and/or the exposed conductor cross-sections 5 are each still completely or partially surrounded by the insulating sheath 11. However, the protruding conductors 13 may be at least partially or completely freed from a cable sheath 8 of the cable 2 over the entire circumference (see FIG. 12).

The connection system 1 may have a guide device 70 shown in FIG. 12, which is formed separately from the cable 2 and the component 20 and/or is movably or detachably connected to the cable 2 and/or the component 20. The guide device 70 may be designed to mechanically guide the contacting in the axial direction A of the cable 2, and preferably to guide the conductors 4, in particular the lines 13, and/or the contact means 28 for contacting in the axial direction A of the cable 2. In other words, the guide device 70 may provide a linear guide for the cable 2 and/or the component 20. When the component 20 and the cable 2 move in a linearly guided manner relative to each other for contacting, this may also be referred to as a contacting movement.

The guide device 70 may have a guide housing 72 with a guide structure 71. In FIG. 12, the guide structure 71 is specifically provided in the form of openings of the guide housing 72 in order to provide the mechanical guide for the respective conductors 4, in particular cables 13, and/or contact means 28. As shown in FIG. 12, the guide structure 71 may be formed on a first side 76 of the guide housing 72 to receive the conductors 4, in particular cables 13, and may be formed on another, opposite second side 77 (facing away from the first side 76) of the guide housing 72 to receive the contact means 28.

The lines 13 in FIG. 12 may have different colors and thus be color-coded. Corresponding colors may also be provided in the area of the openings 71 to facilitate assignment.

Furthermore, at least one coding 50 or counter-coding 27 with the properties as described above may also be provided on the guide device 70, for example in the form of a guide grommet.

A part 44 of the component 20 and/or the guide device 70 in FIG. 12 may seal the contact surface 9 in the connected state and/or mechanically lock it and/or provide anti-twist protection. Here, for example, an O-ring or a sealing lip on the guide device 70 is conceivable as a sealing element. A latching lug (not explicitly shown) or a latching hook may serve as a locking element. A projection or a groove may serve as anti-twist protection.

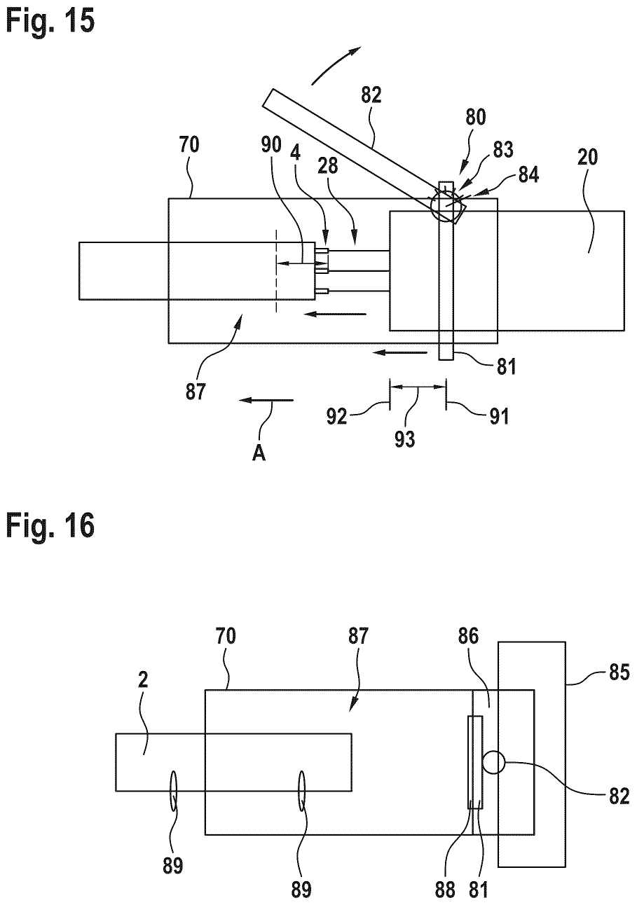

FIGS. 15 and 16 show an example of an insertion mechanism 80, which may be arranged on the guide structure 71 for controlling the contacting movement in order to insert the at least one or the multiple electrical contact means 28 into the associated electrical conductor 4 with a predetermined depth of penetration 90 in an axial direction A of the conductor 4 and/or the cable 2.

The insertion mechanism 80 may be designed to insert, in particular pierce, the respective contact means 28 linearly guided by the contacting movement into the associated electrical conductor 4 with the predetermined depth of penetration 90, in particular depth of piercing 90, the predetermined depth of penetration 90 preferably being in the range from 0.5 mm to 10 mm, preferably 1 mm to 6 mm, preferably 2 mm to 4 mm.

The insertion mechanism 80 may further comprise a pressure element 81 and a transmission arrangement 82. Here, the transmission arrangement 82 may be connected to the pressure element 81 in a force-transmitting manner in order to set the pressure element 81 in motion when force is applied manually or mechanically to the transmission arrangement 82. In this way, the respective electrical contact means 28 may be introduced, preferably pierced, into the associated electrical conductor 4 by the pressure element 81 via the contacting movement. Here, a travel 93 for the pressure element 81 between a starting position 91 and an end position 92 may be determined by the predetermined depth of penetration 90 and/or may be structurally predetermined. Furthermore, an adjusting mechanism 84 may be provided to adjust the predetermined depth of penetration 90 and preferably the travel 93 in the insertion mechanism 80, preferably depending on a cable type of the cable 2 and/or continuously and/or in several predefined stages.

Furthermore, FIG. 15 schematically illustrates that the insertion mechanism 80 may be configured as a lever mechanism 80 in which a transmission arrangement 82 comprises a lever arm 82. This may serve to transmit a manual or machine application of force to the transmission arrangement 82 into the controlled contacting movement, in which the control is such that the contacting movement is linearly guided and/or the depth of penetration 90 is predetermined and/or controlled and/or limited and/or the predetermined and/or a current depth of penetration 90 is indexed for a user.

Furthermore, an indexing device 83, also illustrated in FIG. 15, may be provided in order to visually or haptically or acoustically indicate a current depth of penetration 90 during the contacting movement.

FIG. 16 shows that the insertion mechanism 80 may also have a nut 85, preferably a union nut 85, which is designed to establish a mechanical connection between the component 20 and the cable 2 and to be screwed onto a thread 86 for this purpose. Furthermore, a transmission arrangement 82 may be provided, which is designed to transmit a movement, in particular a rotary movement, of the nut 85 on the thread 86 to a pressure element 81. Furthermore, the pressure element 81 may be arranged and guided in the region of a guide space 87 in order to move through the guide space 87 of the guide structure 71 by the transmitted movement along a longitudinal axis of the thread 86 in order to thereby exert a force for inserting the electrical contact means 28, wherein the guide space 87 is designed to receive a part of the component 20 and/or the at least one electrical contact means 28.

Furthermore, according to FIG. 16, a holding element 88 may be provided, which is firmly connected to the pressure element 81 in order to limit the contacting movement when the holding element 88 encounters a counter-holding element 89.

In FIG. 11, a method 100 for making electrical contact between a cable 2 and a component 20 is schematically visualized. According to a first step 101, the cable 2 may be unwound and/or assembled to a desired length. According to a second step 102, a direct connection of the component 20 to the cable 2 may be established. For this purpose, the component 20 may be directly inserted and/or pierced into the cable 2 or vice versa in order to establish electrical and mechanical contact. Furthermore, a mechanical seal between the cable 2 and the component 20 may be established at least partially or exclusively by establishing the connection.

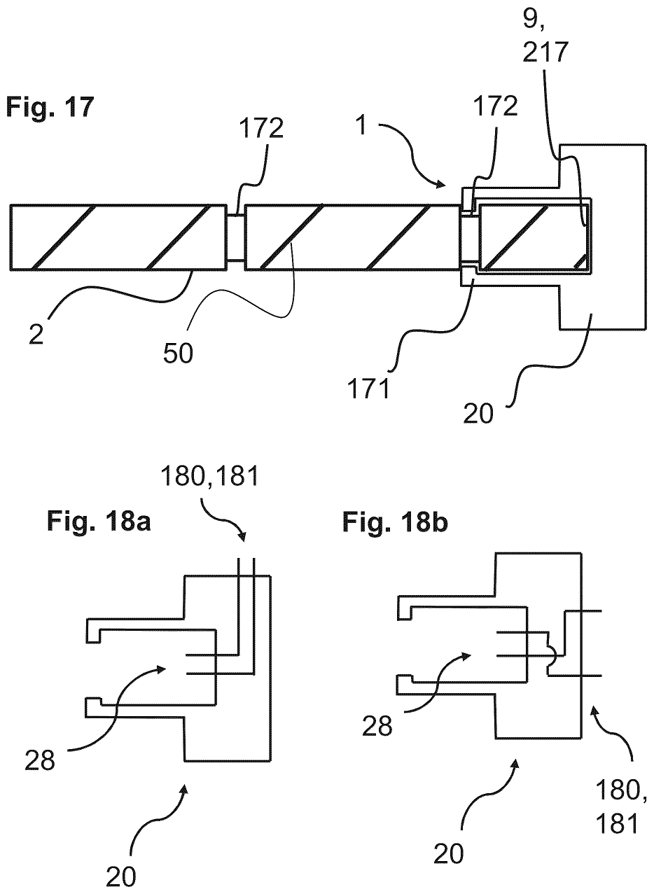

FIG. 17 schematically shows an embodiment of the connection system 1 according to the invention, which comprises an embodiment of the component 20 according to the invention and an embodiment of the cable 2 according to the invention. The cable 2 has a plurality of mutually spaced strain relief contours 172. The strain relief contours 172 are formed as circumferential grooves and are evenly spaced apart along the cable 2. A strain relief 171 of the component 20 engages in such a strain relief contour 172, wherein the strain relief 171 is formed in one piece with the component 20 and prevents that an accidental pulling on the cable 2 leads to an unintentional release of the electrical connection between the cable 2 and the component 20. The electrical connection is established by means of pointed contact means, each of which is pierced into only one predetermined electrical conductor of the cable. The electrical conductors of the cable 2 extend twisted to one another along the length of the cable 2. The cable 2 also has a coding 50 which interacts with a counter-coding of the component 20 in such a way that the contact means of the component 20 only come into electrical contact with the electrical conductors provided for this purpose during the establishment of the electrical connection between the component 20 and the cable 2, in that the coding 50 and the counter-coding together form a guide and prevent any other contact between the conductors of the contact means. For this purpose, the coding 50 of the cable 2 is formed on the circumference of the cable as a helical or threaded groove running in the direction of extension of the cable 2. Alternatively, instead of a groove, an analogously designed bead may be provided. The coding 50 has a continuous course along the direction of extension of the cable 2 and has the same relative position to the electrical conductors of the cable 2 at every point along the extension of the cable 2, transverse or perpendicular to the direction of extension of the cable 2. In other words, the cable 2 may be shortened to a desired length at any point of the cable 2 in order to establish an electrical connection between the cable 2 and the component 20, since the constant relative position along the cable ensures the intended electrical contacting. The contact surface 9 is formed at the cable end 217, at which the contact means are pierced into the conductors of the cable.

FIG. 18a shows a schematic embodiment of the component 20 according to the invention. The contact means 28 for contacting the electrical conductors of the cable may be seen. The contact means 28 lead electrically to contact conductors 180 of a plug 181 of the component 20, where the contact conductors 180 form a plug assembly 181. The course of the guide from the contact means 28 to the contact conductors 180 of the plug 181 is not formed in a straight line, but is angled at least once, preferably vertically, whereby the plug 181 is formed on a side of the component 20 that extends transversely or perpendicularly to the insertion direction of the cable 2. Instead of a plug 181 with a plug assembly 181, a socket with a socket assembly may be provided.

FIG. 18b shows a further schematic embodiment of the component 20 according to the invention, which differs from the embodiment of FIG. 18a in that the plug 181 is formed on a side of the component 20 that faces away from the side of the component 20 on which the cable may make electrical contact with the contact means 28. In addition, the course of the guide from the contact means 28 to the contact conductors 180 of the plug 181 is formed in such a way that the arrangement and/or assignment of the contact conductors 180 of the plug 181 differs from that of the contact means 28.

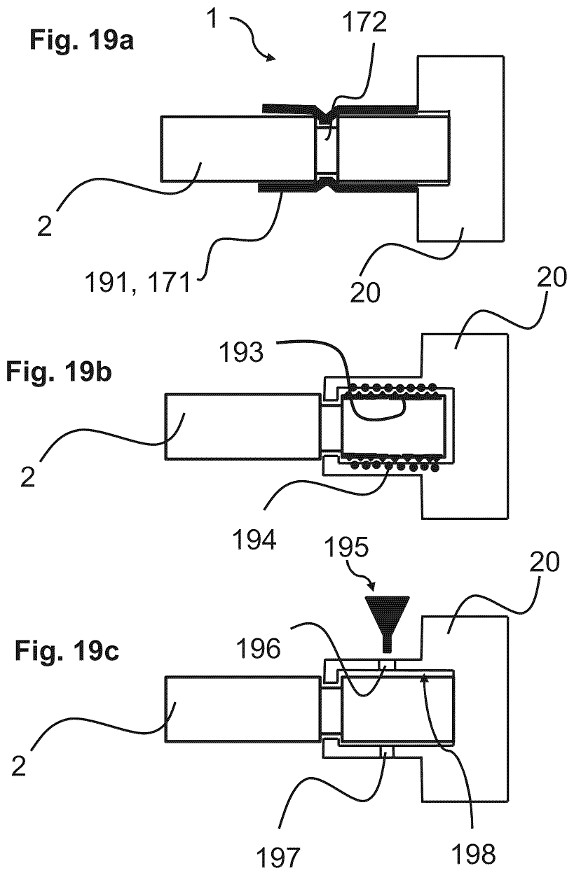

FIG. 19a shows an embodiment of a connection system 1. Here, a strain relief 171 is formed by means of a heat-shrink tubing 191. The heat-shrink tubing 191 also serves to seal the electrical connection between the cable 2 and the component 20. The heat-shrink tubing 191 engages in a circumferential groove that forms the strain relief contour 172. In addition, the heat-shrink tubing is attached to the component 20.

FIG. 19b shows a further embodiment of a connection system 1. Here, the cable 2 has a microencapsulation 193 which, on contact with an activation substance 194, releases a sealing compound which seals the electrical connection between the cable 2 and the component 20 to the environment. Of course, it is also possible that the component 20 has the microencapsulation while the cable 2 has the activation substance. Alternatively, it is also conceivable that the activation, i.e. the release of the microencapsulation, takes place by means of heat or light or radiation or in another suitable manner.

FIG. 19c shows a further embodiment of a connection system 1. Here, a sealing chamber 198 in the component, which is bounded by the cable 2 and the component 20, is sealed to the environment by means of a sealing compound 195. Preferably, the component 20 has a filler opening 196 for filling the sealing compound 195. Furthermore, the component 20 may have an outlet opening 197, from which the filled sealing compound 195 may escape if the sealed chamber 198 is already filled with the sealing compound 195. Alternatively or additionally, it is possible that the component 20 has a viewing window which delimits the sealing chamber 198, whereby a degree of filling of the sealing chamber 198 by means of the sealing compound 195 may be visually identified by a user.

The contact means are not shown in FIGS. 17 and 19a to 19c for ease of representation or are not visible due to the chosen representation.

The foregoing explanation of the embodiments describes the present invention solely by way of examples. Of course, individual features of the embodiments may be freely combined with one another, provided that this is technically expedient, without departing from the scope of the present invention.

### LIST OF REFERENCE SYMBOLS

1 System, connection system
2 cables
4 Core, strand, conductor
6 Cavity
7 Profile
8 Sheath, cable sheath
9 Contact surface, cut surface
10 Filling material
12 Single wire
14 Sealing for condensate
20 Component
22 Locking, unlocking
24 Threaded screw connection
26 Guide, guide means
27 Counter-coding
28 Contact means, pin
29 Safety contact means
30 Pin tip
40 Connector assembly
42 Printed circuit board
44 Locking device, anti-twist protection, seal
45 Locking pin
50 Coding
51 First coding
52 Second coding
60 Structure
62 Depth marker
70 Guide device
71 Guide structure
72 Guide housing
76 First side
77 Second side
80 Insertion mechanism
81 Pressure element
82 Transmission arrangement
83 Indexing device, indexing
84 Adjusting mechanism
85 Nut
86 Thread
87 Guiding space
88 Holding element
89 Counter-holding element
90 Depth of penetration
91 Starting position
92 End position
93 Travel
100 Method
101 First process step
102 Second process step
A Axial direction
217 Cable end
171 Strain relief
172 Strain relief contour
180 Contact conductor
181 Plug, plug assembly
191 Heat-shrink tubing
193 Microencapsulation
194 Activation substance
195 Sealing compound
196 Filler opening
197 Outlet opening
198 Sealed chamber

1. An electrical cable for connection to an electrical component, the cable having at least one electrical conductor,
characterized in that
at least one coding is spatially formed on the cable in order to predetermine a specific arrangement and assignment of electrical contact means of the component with the electrical conductors of the cable.

2. The cable according to claim 1,
characterized in that the at least one coding comprises a mechanical and/or geometric coding of the cable, in which a geometric profile, in particular a spatial shape and/or contour, extends in an axial direction of the cable, the profile preferably defining a guide cavity for a guide means and preferably for a guide pin of the component so that a specific orientation of the component for the connection is predetermined in order to block the connection of the component in the event of a deviation from the specific orientation, wherein the guide cavity is particularly preferably designed for transmitting a fluid, in particular for transmitting a medium such as air or a liquid.

3. The cable according to claim 1,
characterized in that the at least one coding comprises a geometric and/or extruded profile of the cable and/or a tube and/or a grommet, the coding being arranged in the cable, in particular inside a cable sheath of the cable, and/or outside the cable sheath and/or on the cable sheath, a shape of the coding preferably deviating from a basic shape of the cable.

4. The cable according to claim 1,
characterized in that the at least one coding is formed by means of a rotationally symmetry-free cross-section of the cable, in particular by a rotationally symmetry-free inner and/or outer contour of the cable.

5. The cable according to claim 1,
characterized in that the at least one coding additionally comprises an electrical coding of the cable, in which a systematic arrangement of the electrical conductors of the cable is provided, so that a specific assignment of the electrical contact means of the component is predetermined for the connection.

6. The cable according to claim 1,
characterized in that the electrical conductors of the cable are each formed as a strand in order to form a receptacle for inserting at least one electrical contact means of the component, preferably for piercing the contact means in the form of a contacting tip on a contact surface of the cable in an axial direction of the cable, wherein preferably the conductors on the contact surface are directly adjacent to an outer region of the cable.

7. The cable according to claim 1,
characterized in that a recurring marking is provided which indicates a depth of penetration of the electrical contact means, preferably in the form of piercing means.

8. The cable according to claim 1,
characterized in that the electrical conductors merely and/or directly extend and/or adjoin a or the contact surface of the cable, preferably in order to enable piercing of the contact means, in particular in the form of contacting tips and/or piercing means, into the electrical conductors at the contact surface,
that the contact surface preferably extends transversely, in particular perpendicularly, to the direction in which the cable extends,
and in that, in particular, the contact surface forms a cut surface of the cable, at which the cable has preferably been shortened to a desired length, and/or a cable end of the cable.

9. The cable according to claim 1,
characterized in that the cable has along its extension on its outer circumference, preferably at regular intervals from one another, a plurality of contours, in particular strain relief contours, particularly preferably in the form of circumferential recesses, in particular grooves or notches, or elevations, in particular beads or steps, preferably for a heat-shrink tubing or a strain relief.

10. The cable according to claim 1,
characterized in that the cable, in particular on the outer circumference of the cable and/or on the contact surface, has a microencapsulation for forming a seal, the contents of the microencapsulation being releasable in particular by the supply of heat, radiation, in particular the supply of light, preferably in the form of ultraviolet light, contact with an activation substance or the supply of light in combination with moisture, or
in that the cable has, in particular on the outer circumference and/or on the contact surface, an activation substance for a microencapsulation in order to release the contents of the microencapsulation on contact with the microencapsulation in order to form a seal.

11. The cable according to claim 1,
characterized in that the electrical conductors of the cable are twisted together, in particular in the form of one or more twisted pairs, twisted threes or twisted fours, in that the at least one coding has a continuous course along the length of the cable and a course matched to the twisting such that at each point of the cable along the length of the cable the at least one coding and the electrical conductors have the same relative position to one another, in particular in a plane transverse, preferably perpendicular, to the direction in which the cable extends.

12. The cable according to claim 1,
characterized in that the cable has a fluid line, in particular a liquid line or gas line, the at least one coding being formed partially or only by means of the fluid line, that the electrical conductors, in particular the stranding or strandings, surround the fluid line along the extension of the cable, preferably in order to ensure uniform cooling of the conductors by means of the fluid which may be conducted through the fluid line.

13. A component for connection to an electrical cable, the cable having at least one electrical conductor, wherein at least one coding is spatially formed on the cable in order to predetermine a specific arrangement and assignment of at least one electrical contact means of the component with the at least one electrical conductor of the cable,
comprising:
the at least one electrical contact means for making an electrical contact with the at least one electrical conductor of the cable in an axial direction of the cable,
characterized in that
the at least one electrical contact means is designed to make the electrical contact in the electrical cable.

14. The component according to claim 13,
characterized in that the component further comprises:
a counter-coding in order to predetermine a specific arrangement and assignment of the at least one electrical contact means with the at least one electrical conductor of the cable during the connection, preferably in that the counter-coding interacts with the coding of the cable and/or is matched to the coding of the cable,
in particular at least one guide pin, which is designed to provide an axial guide in the connection, preferably of the component in the cable and/or of the cable, and is preferably designed as the counter-coding, the guide pin preferably being designed to lead in relation to the at least one contact means.

15. The component according to claim 13,
characterized in that the component further comprises:
the at least one contact means, in each case in the form of a piercing means, which is designed to be pierced into an associated electrical conductor of the cable in the form of an electrical strand in the axial direction of the conductor, preferably into an exposed conductor cross-section of the conductor,
wherein preferably several, preferably at least three or at least four or at least five, contact means are provided in order to electrically contact one of the conductors of the cable in each case.

16. The component according to claim 13,
characterized in that at least one of the contact means is designed as a safety contact means, which is designed to lead in relation to at least one or all of the other contact means in order to contact one of the electrical conductors of the cable before the at least one or the other of the contact means when the connection is made.

17. The component according to claim 13,
characterized in that a sealing means is provided in order to achieve a seal between a cable sheath of the cable and the component during an assembly to establish the connection.

18. The component according to claim 13, characterized in that
the multiple contact means, in particular the configuration and/or arrangement and/or dimensioning of the multiple contact means, are designed for the electrical conductors, in particular the dimensioning and/or the course of the electrical conductors and/or the arrangement of the electrical conductors on the contact surface,
that an electrical contacting of several electrical conductors by means of only one of the contact means, in particular by one of the contact means electrically contacting a first electrical conductor in the contact surface and a further electrical conductor in the direction of extension of the cable behind or next to the first electrical conductor, preferably due to the twisting of the electrical conductors, is excluded.

19. The component according to claim 13, characterized in that,
the component has a strain relief for the cable, which is designed to interact with one of the contours, in particular with one of the strain relief contours, of the cable, preferably in the form of a circumferential recess, in particular groove or notch, or elevation, or elevation, in particular bead or shoulder, in such a way that the cable is strain-relieved, and/or
in that the component has a heat-shrink tubing and a fastening, preferably in the form of a fastening contour, for the heat-shrink tubing in order to form the strain relief for the cable, in particular by means of the heat-shrink tubing.

20. The component according to claim 13, characterized in that the component, in particular in regions for contact with the outer circumference and/or the contact surface of the cable, has a microencapsulation for forming a seal, the contents of the microencapsulation being releasable in particular by the supply of heat, radiation, in particular the supply of light, preferably in the form of ultraviolet light or ultraviolet radiation, contact with an activation substance or the supply of light in combination with moisture, or
in that the component, in particular in regions for contact with the outer circumference and/or the contact surface of the cable, has an activation substance for a microencapsulation, in order to release the contents of the microencapsulation on contact with the microencapsulation.

21. The component according to claim 13, characterized in that the contact means lead electrically to electrical contact conductors of a plug assembly or socket assembly of the component, in that the position and/or arrangement and/or assignment and/or dimensioning of the electrical contact conductors differs from that of the contact means, in particular on the contact surface.

22. The component according to claim 13, characterized in that the component has a fluid channel for a fluid-transmitting connection to the fluid line of the cable.

23. The component according to claim 13,
characterized in that the component is designed as a plug or a sensor or an actuator or a module, preferably for use in industrial automation, preferably in an electrical plant for industrial automation.

24. A connection system, comprising
an electrical cable for connection to an electrical component, the cable having at least one electrical conductor, and at least one coding is spatially formed on the cable in order to predetermine a specific arrangement and assignment of at least one electrical contact means of the component with the at least one electrical conductor of the cable,
the system further comprising:
the electrical component for connection to the electrical cable, wherein the component comprises the at least one electrical contact means for making an electrical contact with the at least one electrical conductor of the cable in an axial direction of the cable,
characterized in that
the at least one electrical contact means is designed to make the electrical contact in the electrical cable.

25. The connection system according to claim 24, characterized in that an electrical connection is established between the cable and the component, in particular in that the contact means are pierced into associated conductors, the connection system comprising a seal, in particular a material-locking and/or force-locking and/or form-locking seal which seals the connection and in particular a cable section adjacent to the connection with respect to an environment of the connection system, in particular in accordance with IP20 or IP67, in that the seal is preferably, in particular in the case of a form-locking seal, the seal is formed by means of a heat-shrink tubing or the heat-shrink tubing which forms the strain relief.

26. The connection system according to claim 25, characterized in that the seal seals and/or electrically insulates a transition from the fluid line to the fluid channel in a fluid-tight manner with respect to the contact points, which are formed by means of contactings of the conductors with the contact means on the contact surface, and/or wherein the seal electrically insulates and/or seals the contact points, which are formed by means of contactings of the conductors with the contact means on the contact surface, with respect to one another.

27. The connection system according to claim 25, characterized in that the seal is formed by means of a sealing compound, in particular adhesive or potting compound, wherein, in particular in the direction of extension of the cable and/or perpendicular to the direction of extension of the cable a sealing chamber for receiving the sealing compound is formed between the cable, in particular the contact surface of the cable, and the component, in which the sealing compound is located and preferably completely fills the sealing chamber, wherein the sealed chamber preferably has a filler opening for the sealing compound, which is in particular closed by the sealing compound, wherein the sealed chamber preferably has an outlet opening for the sealing compound, which is closed in particular by the sealing compound, wherein in particular a section of the component delimiting the sealed chamber is formed from a transparent material so that the degree of filling of the sealing chamber with the sealing compound may be determined optically.

28. The connection system according to claim 25, characterized in that the seal is formed by means of a released content of the microencapsulation, in particular of the cable or the component.

29. The connection system according to claim 24, wherein an attachment of the cable to the component is formed by means of a force-fit and/or form-fit and/or material-fit connection.

30. The connection system according to claim 24, characterized in that the component has a strain relief, in particular a heat-shrink tubing formed as a strain relief, which is preferably fastened to the component, for the cable, in that the strain relief interacts with one of the contours, in particular one of the strain relief contours, of the cable in such a way that the cable is strain-relieved by the strain relief interacting in particular with the contours, in particular one of the strain relief contours, of the cable, in particular one of the strain relief contours of the cable in such a way that the cable is strain-relieved in that the strain relief forms a form-fit in particular with the contour, in particular strain relief contour, of the cable, preferably in that the strain relief engages behind the contour, in particular strain relief contour, or engages in the strain relief contour.

31. The connection system according to claim 24, characterized in that the connection system comprises an insertion mechanism, in particular a screw mechanism, a lever mechanism or a plug-in mechanism, to perform the contacting movement, the insertion mechanism preferably being designed to move the cable in the direction of the component during the contacting movement, the connection system or the insertion mechanism preferably comprising an adjusting mechanism, for setting a predetermined depth of penetration of the contact means into the conductor at the insertion mechanism, preferably as a function of a cable type of the cable and/or continuously and/or in several predefined stages, wherein the connection system or the insertion mechanism preferably has an indexing means which is designed to index the current depth of penetration for a user during the contacting movement.
